(19) United States
(12) Patent Application Publication
(10) Pub. No.: US 2025/0042110 A1
(43) Pub. Date: Feb. 6, 2025

(54) Method for Producing Spectacles Lenses, and a Positioning Receptacle for/having a Spectacles Lens Semifinished Product

(71) Applicant: Satisloh AG, Baar (CH)

(72) Inventors: Johannes Claar, Ebsdorfergrund (DE); Holger Schäfer, Weilmünster (DE); Steffen Wallendorf, Wetzlar (DE); Michael Kreis, Gründau (DE)

(21) Appl. No.: 18/718,741

(22) PCT Filed: Dec. 13, 2022
(86) PCT No.: PCT/EP2022/085717

§ 371 Date: Jun. 11, 2024

(30) Foreign Application Priority Data
Dec. 13, 2021 (DE) 10 2021 006 153.5

(51) Int. Cl. B29D 11/00

(52) U.S. Cl. CPC B29D 11/00432

(57) ABSTRACT

A method for producing spectacles lenses (10), in which method, starting with a blank which has predetermined surface geometries on a front face (12) and a rear face (14) remote therefrom and having a contoured edge (16) therebetween, a finished part is formed by material removal and/or deposition. In a step of generating an optically active shape of the spectacles lens, the semifinished product is shaped, which has an edge region (18) in which an orientation structure (20) is also made. For at least one subsequent step of further machining, the location and position of the semifinished product in space are clearly identified and established with the aid of a positioning receptacle (22) arranged in a defined manner in space.

### TECHNICAL FIELD

The present invention relates generally to a method for producing spectacle lenses. In particular, the invention relates to a method for producing spectacle lenses of plastic, for example polycarbonate, CR39 or so-called “high index” materials such as widely practiced in so-called “RX workshops”, i.e. production facilities for production of individual spectacle lenses according to prescription. Moreover, the invention relates to a positioning retainer for a spectacle lens semi-finished product which can be used in such a method as well as to a combination of such positioning retainer and a spectacle lens semi-finished product.

The method described herein and also the positioning retainer described herein are very well suited for use, for example, in combination with or in a method for processing of spectacle lenses by machining, such as described in earlier German patent applications DE 10 2021 004 831.8 and DE 10 2021 005 399.0 of the same applicant and/or use in conjunction with a workpiece retainer such as is the subject of earlier German patent application DE 10 2021 005 202.1 of the same applicant and/or with a workpiece holding head such as described in earlier German patent application DE 10 2021 005 399.0 of the same applicant. With respect to method and device details in question here specific reference is made at this point first of all to the explanations with respect thereto in the aforesaid earlier German patent applications.

### PRIOR ART

In the first above-mentioned earlier German patent application there has already been detailed description of those process steps which currently are usually performed in RX workshops in the industrial production of spectacle lenses, so that the usual procedure need be only very briefly outlined at this point. The starting product in industrial production of spectacle lenses is a semi-finished spectacle lens blank, also termed “blank”, which has one optically effective surface already processed to finished state and provided by injection molding or preshaped in some other way and which is to be processed at its other optically effective surface and at the edge between the optically effective surfaces to form a finished spectacle lens.

In that case, as explained in this earlier German patent application in detail on the basis of FIGS. 16 and 17 and with citations relating to respectively relevant prior art—to which reference may again be made here—the following process steps are usually carried out in sequential succession: a) so-called “blocking” of the spectacle lens blank at a blocking member with the sub-steps of establishing position as well as positioning and fixing on the blocking member, b) so-called “generating” with the sub-steps of preliminary edge processing and surface processing, c) polishing and d) marking, wherein the process steps b) to d) are performed at the blocked workpiece, then e) so-called “deblocking” of the workpiece from the blocking member, f) coating and g) so-called “edging” with the sub-steps of recognizing position as well as final processing of edge shape, for which purpose use is made of a so-called “edger”. In the process steps b) to d) the blocking member represents a retainer or machine interface for the processing of the workpiece so as to be able to rotationally drive the workpiece during processing and to always reliably hold it in a defined position and orientation in three dimensions.

The previously known process chain outlined in that regard includes with the above process steps of a) blocking and e) deblocking two sequences which represent necessary auxiliary processes, but do not themselves enhance the value of the produced spectacle lens. A process chain managing without these auxiliary processes would thus be desirable. In particular, for increasing efficiency and also for ecological considerations it has already been proposed in the prior art to work “blocklessly” in the production of optically effective surfaces of spectacle lenses (see, for example, documents WO 2015/059007 A1, U.S. Pat. No. 9,969,051 B2, DE 10 2016 112 999 A1, DE 10 2004 016 445 B4, EP 2 631 033 B1 and DE 103 10 561 A1)

Thus, by way of example, the last-mentioned document DE 103 10 561 A1 discloses a method for production of spectacle lenses to prescription or to individual prescription in which use is made of plastics material blanks in the form of flat, round discs. The plastics material blanks used are clamped at the outer edge and thereafter the desired final surface geometry and surface quality of the convex lens front side and the concave lens rear side are produced by machining with milling and/or turning tools as well as by fine grinding and optionally polishing. During the processing an annular region of greater thickness remains at the outer circumference of the workpiece. This annular region serves in all processing and transport procedures for clamping or depositing the workpiece. Moreover, it supports and stabilizes the actual spectacle lens for the further processing. Shapings—for example in the form of flattenings or recesses—serving for identification of the processing axes are applied to the annular region. Moreover, fine markings serving for characterization of the axial position of the surface geometries produced are applied to the surface of the actual spectacle lens. The spectacle lens is subsequently separated from the annular region.

However, the concepts disclosed in the documents mentioned above with respect to previously published prior art provide only inadequate support of the workpiece at the counter-surface during surface processing of the spectacle lenses and/or function with mechanically applied holding forces engaging in radial direction at the workpiece edge or in axial direction in the workpiece center. Both of these—inadequate support and radially or axially applied mechanical holding forces—involve the risk of undesired lens deformations, which ultimately can detract from processing quality, as discussed in detail in the two earlier German patent applications DE 10 2021 004 831.8 and DE 10 2021 005 202.1 of the applicant. The three aforesaid earlier German patent applications already indicate solutions as to how the important holding and supporting of the spectacle lenses take place in a basically two-stage procedure—initially workpiece retention at the rear side and processing at the front side of the workpiece near the blank edge, thereafter retention of the front side and processing at the rear side of the workpiece also in the center—and in particular through defined method sequences (DE 10 2021 004 831.8) and/or a defined configuration of the devices provided for workpiece retention at the rear side (DE 10 2021 005 399.0) or at the front side (DE 10 2021 005 202.1)—for details with respect thereto see the three aforesaid earlier German patent applications.

The earlier German patent application DE 10 2021 005 399.0 is, moreover, also already concerned with the subject of how without use of a blocking member in an efficient process chain for processing of spectacle lenses by machining it can be ensured that the position and orientation of the workpiece in three dimensions are always unambiguously known. In this regard, account is to be taken of the fact that, inter alia, spectacle lens blanks do not necessarily have to be rotationally symmetrical workpieces, but these can have, especially at the preshaped front side, also surface geometries which differ from spherical or flat geometries, for example toroidal surface geometries. There have also been approaches in the spectacles industry to divide so-called “freeform surfaces” into front side and rear side of the spectacle lenses so that a spectacle lens blank as starting product of the process chain can already have at the front side a comparatively complex, asymmetrical geometry. It is obviously very important particularly with such an approach to ensure that the surface geometry, which is to be produced, at the rear side is with respect to its location, i.e. position in three dimensions, and also with respect to its position, i.e. orientation in three dimensions, generated appropriately to the surface geometry of the front side so as to achieve the desired optical effect. This takes place only when in that regard the position and orientation of the entire workpiece in three dimensions are unambiguously defined.

For that purpose a method for processing of spectacle lenses by machining is proposed in earlier German patent application DE 10 2021 005 399.0, the method generally comprising the following main steps: i) providing the blank, which is to be processed at least at the rear side; ii) fixing and determining the location and position of the blank in three dimensions; iii) block-free retention of the blank at the rear side with consideration of the location and position data, which were determined in the main step ii), by a workpiece holding head, which is arranged to be positionable in defined manner in three dimensions, for supported holding of the workpiece; iv) measuring the blank, which is held by the workpiece holding head, at the front side for detection of the front side geometry; v) direct transfer of the workpiece from the workpiece holding head to a workpiece retainer, which is arranged to be positionable in defined manner with respect to position and angle, for block-free retention of the workpiece at the front side with consideration of the front side geometry data, which were detected in the main step iv), and for supported holding of the workpiece; and vi) processing the workpiece at the rear side by at least one tool, for formation of the semi-finished product with the predetermined surface geometry at the rear side; wherein the workpiece is held without interruption at the workpiece holding head between the steps iii) and v) so that the location and position of the workpiece in three dimensions are always clearly defined.

In simple terms, in this procedure the workpiece to be processed is thus “taken in hand” from the workpiece holding head in method step iii) and, in particular, from a position and with an orientation in three dimensions known in accordance with the method step ii) and “put down” only again when the workpiece in method step v) is transferred to the workpiece retainer, for example of a generator. In the interim the workpiece is not “put down” from the workpiece holding head, so that the position and orientation of the workpiece in three dimensions are always unambiguously defined. Only after transfer of the workpiece to the workpiece retainer, for example of the generator, in step v) do “responsibility” and control with respect to position and orientation of the workpiece lie thereat. Thus, in accordance with this concept the workpiece holding head in a defined section of the method for processing of spectacle lenses by machining quasi “takes over” the functions of the blocking member in the previously known prior art, but without the necessity of use of a blocking member and consequently without the disadvantages connected therewith.

A further challenge of “blockless” processing arises-after generation of the optically active shape of the spectacle lens-due to the location and position data which are absent without a blocking member and which in the prior art are transferred by way of the blocking member from one processing machine to the next processing machine. These location and position data are, for example, needed in the marking process and in the final edge processing of the spectacle lens semi-finished product in the edger. The present invention is concerned with this subject.

One possibility of obtaining appropriate information includes re-establishing location and position of the partly processed spectacle lens semi-finished product at the start of the following process, such as in the marking device, for example a laser graver, or in an edger as edge processing device. For example, determination of the necessary data by measurement by a combination of optical measuring devices, such as already used in part in edgers, is conceivable here. However, this is connected with a comparatively high outlay with respect to device technology and moreover is time-intensive in actual use.

Further, in this connection, it can also be generally inferred from document DE 10 2016 112 999 A1 (see paragraph thereof), which is mentioned above with respect to the “blockless” prior art, that small indentations serving for orientation during the processing, particularly when rotationally asymmetrical surfaces are produced, can be formed at the round circumferential edge of a spectacle lens blank to be processed at the surface, i.e. prior to the generating. Furthermore, document EP 2 631 033 B1, which was also cited above with respect to the “blockless” prior art, discloses a method and device for processing of spectacle lens blanks in which an optional sub-step of this method includes executing an orientation groove program with a milling tool in which an orientation groove is milled into the radial circumference of the spectacle lens blank (cf. claim 16 thereof). In later surface processing steps this enables rapid orientation of the spectacle lens blank (see paragraph [0055]). However, further details with respect thereto are not communicated by this prior art.

Document U.S. Pat. No. 9,415,478 B2, in this connection, is also focused on a method for production—optionally also possible “blocklessly”—of a spectacle lens by machine processing, the lens having a first side and a second side opposite the first side, wherein the first side is provided with a first optical region and the second side with a second optical region and wherein the first and second optical regions define an optically usable zone of the spectacle lens.

The method disclosed therein comprises in detail the following steps: (a) providing a lens blank with a front side, a rear side opposite the front side and a circumferential edge surface connecting the front and rear sides; (b) providing a first holding device with a first processing reference system which is defined by three translational directions corresponding with the three axes of an orthonormal basic co-ordinate system and by three rotational directions running around the three translational directions, wherein two of the three translational directions lie in one and the same first plane and the other one of the three translational directions lies in a second plane; (c) retaining the lens blank at the first holding device in a first position in which the rear side of the lens blank faces the first holding device, which is designed in such a way that it holds the lens blank—for example with the help of vacuum—by way of its rear side or by way of its circumferential edge surface; (d) processing the front side in the first position in the context of the first processing reference system in order to obtain the first optical region and thus form a semi-finished lens blank; (e) forming in the context of a second processing reference system, which is defined in the same manner as the first processing reference system, at least one mechanical reference element—for example in the form of an encircling groove—in at least one of the front side and rear side and the circumferential edge surface, wherein the second processing reference system has a defined relationship to the first processing reference system and is known and the processing step is designed in such a way that the at least one mechanical reference element is outside the optically usable zone so as to thus form a referenced lens blank; and (f) providing a second holding device comprising at least one complementary mechanical reference element which is configured in such a way that it co-operates with the at least one mechanical reference element of the referenced lens blank so that the latter is positioned and held on the second holding device in a second position defined at least in the three translational directions and in the two rotational directions of the first plane.

The at least one mechanical reference element at the lens blank is in that case generally formed by formation of at least one chamfered zone, which is produced at least in the circumferential edge surface and either in the front side or rear side outside the optically usable zone, whereas the at least one complementary mechanical reference element is formed by at least one shoulder at the second holding device, which is designed so that it enters into contact with the at least one chamfered zone of the referenced lens blank.

In this prior art a reference element is thus formed outside the optically usable zone at the semi-finished lens blank after processing of the front side, so as to obtain a referenced semi-finished lens blank which for processing of the rear side is retained in a second holding device in which the referenced semi-finished lens blank is then positioned and oriented by its reference element mechanically positively coupled with a mating geometry, i.e. the complementary mechanical reference element of the second holding device. The processing of the referenced semi-finished lens blank retained and held in the second holding device shall, in this prior art, then comprise-apart from processing of the rear side by machining, for example by turning-processing of the circumferential edge surface by machining, polishing of the rear side and engraving of the rear side. The spectacle lens is separated from the second holding device only after that.

However, particularly in large industrially focused “RX workshops” it now frequently happens that the individual processing steps, which are still required after generation of the optically active shape of the spectacle lens and which comprise, in particular, polishing, marking, coating and forming of a rim shape, are performed in physically separate production cells or facilities and/or—for example for the purpose of utilization of capacity—at a specific spacing in time from one another. The concept outlined above, in which the individual (successive) processing steps are carried out “in a clamped state” in the second holding device, is not suitable for such requirements. A greater degree of flexibility of the method, which involves different sizes or diameters of the lens blanks to be processed, would also be desirable especially in conjunction with industrial production of spectacle lenses.

Finally, document U.S. Pat. No. 10,215,888 B2 discloses a similar method for production of an optical lens with a first surface and second surface opposite the first surface, the method including positioning of the second surface relative to the first surface for processing of the second surface. Also in this prior art, after processing of the front surface of the spectacle lens blank, positioning guides, here in the form of cylindrical chamfered and flat sections at the edge of the produced spectacle lens semi-finished product are formed by machining and in a succeeding step—which can also take place in a different production facility—serve the purpose of positioning and orienting the spectacle lens semi-finished product in an associated positioning ring with corresponding mating geometries before processing of the rear surface of the spectacle lens semi-finished product is carried out. However, in this prior art not only the spectacle lens blank for processing of the front surface, but also the spectacle lens semi-finished product for processing of the rear surface are each, after application of a protective layer, blocked at a blocking and holding pin or at the positioning ring by a blocking material, such as a liquid metal alloy, before the respective processing takes place, after which deblocking of the processed workpiece has to be carried out again. The present invention will obviously avoid such protective, blocking and deblocking steps.

### Object

By comparison with the prior art outlined in that regard the present invention has the object—firstly—of creating a simplest possible method for production of spectacle lenses which without use of a blocking member addresses the afore-described problems and, in particular, enables continuous, precise and high-quality workpiece processing in an efficient manner. Moreover, the object of the invention includes—secondly—provision of a simply constructed positioning retainer, which is usable as flexibly as possible even for different workpiece dimensions, for a spectacle lens semi-finished product, particularly for use in the above method, which allows recognition and establishing as precisely as possible of the location and position of the spectacle lens semi-finished product in three dimensions as well as—thirdly—a combination of such a positioning retainer with a spectacle lens semi-finished product which is, in particular, suitably prepared in the course of the above method.

### Illustration of the Invention

These objects are fulfilled by a method for producing spectacle lenses by the method steps according to claim 1, a positioning retainer for a spectacle lens semi-finished product, particularly for use in the method according to the invention, with features corresponding with claim 8, as well as a combination of such a positioning retainer and a spectacle lens semi-finished product, which is suitably prepared or provided particularly in the course of the method according to the invention, with the features of claim 15. Advantageous or expedient embodiments and developments of the invention are the subject of the dependent claims.

According to the invention a method for producing spectacle lenses, in which beginning with a blank and via a semi-finished product a finished part with predetermined surface geometries at two sides, namely a front side and a rear side remote therefrom, and with a contoured edge between the two sides is formed by removal and/or application of material, comprises the following main steps: i) providing or creating the blank, which is to be processed at at least one side as well as at the edge; ii) generating an optically active shape of the spectacle lens by removal and/or application of material on at least one side of the blank for formation of a semi-finished product having an edge region; followed by at least one further main step from a group of main steps iii) to vi), comprising the main steps: iii) polishing the semi-finished product at at least one of the sides for reducing surface roughness; iv) marking the semi-finished product at at least one of the sides with a permanent marking; v) coating the semi-finished product at at least one of the sides for enhancement of workpiece quality; vi) forming a frame shape of the spectacle lens by removal and/or application of material in the edge region; with the features that the main step ii) of generating comprises a sub-step ii.c) in which an orientation structure is formed in the edge region of the semi-finished product; that in a following step there is provided a positioning retainer which is placeable in three dimensions in defined manner and with the help of which the location and position of the semi-finished product in three dimensions are unambiguously recognized and fixed, for which purpose the positioning retainer comprises a positioning structure with which the semi-finished product is aligned by mechanically positive couple by its orientation structure in the edge region; and above all that the semi-finished product, which is retained at the positioning retainer and positioned and orientated in that way, together with the positioning retainer is transported for further processing in at least one of the further main steps iii) to vi) in which re-establishing of location and position of the semi-finished product is unnecessary.

The present invention thus at the outset makes use of the circumstance that the location or position as well as the place or orientation of the spectacle lens semi-finished product in three dimensions are known in the main step ii) of generating the optically active shape of the spectacle lens. In this connection, “optically active shape” generally means the light-permeable or light-refractive surface shape or curvature of the spectacle lens, which has a corrective effect relative to faulty vision—such as, for example, in the case of spectacle lenses according to prescription—or, however, may have no corrective effect, such as, for example, in the case of simple sunglass lenses. Instead of now reproducing in the location and position of the spectacle lens semi-finished product in three dimensions in conventional mode and manner by way of a blocking member at subsequent further main steps of the spectacle lens production, according to the invention in the course of the main step ii) of generation the orientation structure is formed in the edge region of the spectacle lens semi-finished product and unambiguously defines the position and orientation of the spectacle lens semi-finished product in three dimensions.

By virtue of this orientation structure—which is temporary and no longer needed after matching to or fitting in the frame shape of the spectacles frame—at the spectacle lens semi-finished product the location and position of the spectacle lens semi-finished product for the main steps of spectacle lens production following the main step of generating can be easily found by the positioning retainer, which has a corresponding or complementary positioning structure, by way of engagement with a mechanically positive couple. For that purpose the spectacle lens semi-finished product subsequently to the main step of generating is placed in the positioning retainer, which is provided at a defined place in three dimensions and in which the spectacle lens semi-finished product is aligned by mechanically positive couple, so that the location and position of the spectacle lens semi-finished product in three dimensions are now known and do not have to be determined yet again for or in the following process or processes.

For further processing in at least one of the listed further main steps iii) to vi), according to the invention the spectacle lens semi-finished product retained in the positioning retainer in clearly defined manner is now moved or transported together with the positioning retainer to the appropriate production cell or facility responsible for the respective main step. In that case the positioning retainer itself can, for example, be mechanically positively received or frictionally mounted in a work or prescription box or can be an integral component of the box. Such a positioned and oriented transport of the spectacle lens semi-finished product allows at every point of the following process a quasi “blind” removal of the spectacle lens semi-finished product from the positioning retainer so as to transfer the spectacle lens semi-finished product for the respective further main step of the main steps iii) to vi) with known position and orientation to the appropriate further processing device. Re-establishing of position and orientation of the spectacle lens semi-finished product and the outlay in terms of device and time connected therewith can thus be saved in the respective main step. The procedure between the further main steps iii) to vi) can be correspondingly efficient, i.e. the spectacle lens semi-finished product after the respective processing can be put back in the positioning retainer and then transported, together with the positioning retainer with position and orientation again clearly defined, to the production cell or facility for the next main step.

By comparison with optical methods for obtaining data about the location and position of the partly processed spectacle lens semi-finished product, a significant advantage of the recognition and fixing with respect to position and orientation of the spectacle lens semi-finished product by mechanical interlocking is also that this form of obtaining information by “aligning” is very robust and largely independent of environmental influences such as light or darkness, dryness or wetness, etc. According to the invention, the combination of positioning structure at the positioning retainer and orientation structure, which is formed to be complementary therewith or matching thereto, at the spectacle lens semi-finished product, for different main steps of the method for producing spectacle lenses thus quasi “takes over” a principal function of the blocking member in the prior art without, however, the necessity of use of a blocking member and consequently without the disadvantages connected therewith.

With respect to the individual main steps of the method according to the invention it may also be observed at this point that in the main step i)—as currently preferred—a preshaped blank can be provided which still has to be processed in the following steps, but alternatively thereto a blank can also be created firstly by an additive manufacturing method, such as, for example, 3D printing or the like, before processing in the following steps takes place. Equally, in the main step ii) of generating, the optically active form of the spectacle lens can be formed by a material-removing, i.e. subtractive, method or by a material-adding, i.e. additive, method, wherein the spectacle lens semi-finished product which is produced has or gains in each case an edge region which is the location for application of the afore-mentioned orientation structure.

Of the further main steps iii) to vi) one, several or all main steps are performed in correspondence with the respectively desired method result (finished spectacle lens), wherein at the start of the respective further main step the location and position data with respect to the spectacle lens semi-finished product are known by virtue of the mechanically positive co-operation of orientation structure at the workpiece and positioning structure at the conjunctively transported aid of positioning retainer and can be passed on. In the case of the main step iii) of polishing, the location and position data with respect to the spectacle lens semi-finished product can serve the purpose, for example, of proceeding with a specific polishing strategy in which the polishing tool comes into engagement with the workpiece at a predetermined point and leaves the workpiece again at a predetermined point. In the case of the main step iv) of marking, the location and position data transferred with respect to the spectacle lens semi-finished product can be utilized, for example in the case of variable effect lenses, to form the standard details (marking for orientation, details of near-addition effect or change in effect, manufacturer information) permanently—for example mechanically or by a laser—at a predetermined place of the spectacle lens semi-finished product. In the main step v) of coating, the location and position data with respect to the spectacle lens semi-finished product can be used, for example, for the purpose of forming a gradient tinting in a predetermined orientation at the spectacle lens semi-finished product by a suitable coating method (vacuum or dip coating, printing or the like) or for enhancement of lens quality by laminating-on a prepared patch at a defined place and/or with a specific orientation on the spectacle lens semi-finished product, etc. Finally, in the main step vi) of forming the frame shape of the spectacle lens—insofar as required—the location and position data transferred with respect to the spectacle lens semi-finished product can obviously serve in a manner known per se for the purpose of deriving the finished spectacle lens, in a given case with edge and/or mean thickness optimization, from the “right” region of the spectacle lens semi-finished product and with correct orientation with respect to the desired optical effect, for example by “edging” in the case of a subtractive form of formation of geometry. The corresponding applies to the—subtractive or additive—formation of any securing structures for the respective spectacles frame at the spectacle lens semi-finished product, such as facets, steps or shoulders, bores, etc., which can (also) be the subject of this main step vi).

The spectacle lens semi-finished product can be manually or automatically moved or transported together with the positioning retainer between the main steps ii) to vi). The initial placing of the spectacle lens semi-finished product, which is provided with the orientation structure, in or at the positioning retainer for mechanically positive orientation of the spectacle lens semi-finished product prior to further transport for the respective main step iii) to vi) can be carried out, for example, with the help of the workpiece holding head disclosed in earlier German patent application DE 10 2021 005 399.0 of the same applicant.

According to the invention, in terms of device a positioning retainer for a spectacle lens semi-finished product, particularly for use in the above method for production of spectacle lenses, is proposed, with a base body having a center axis and carrying the positioning structure, which has at least three positioning sections—which are placed in an irregular arrangement about the center axis and are formed by projections—for the spectacle lens semi-finished product, these projections extending at an inclination with respect to the center axis of the base body and/or being arranged to be radially displaceable with respect to the center axis, wherein the positioning structure has overall a geometry with which the orientation structure at the spectacle lens semi-finished product can be formed to match so that through a mechanically positive couple between the positioning structure at the positioning retainer and the orientation structure at the spectacle lens semi-finished product the location and position of a spectacle lens semi-finished product retained at the positioning retainer can be unambiguously and clearly defined with respect to the base body.

The effect of projections, which are inclined with respect to the center axis, of the positioning structure at the positioning retainer is, in particular, that for spectacle lens semi-finished products with different outer diameters it is not necessary to stock individual, i.e. respectively different, positioning retainers, but rather one and the same positioning retainer is basically suitable for retention of spectacle lens semi-finished products with different outer diameters. However, as an alternative or in addition thereto the projections for that purpose can for adaptation to different workpiece diameters also be arranged to be radially displaceable with respect to the center axis, which in the case of an embodiment of the positioning retainer with projections oriented parallel to the center axis advantageously also enables deposit and orientation of spectacle lens semi-finished products with different lens diameters.

Moreover, this aspect of the present invention is to be regarded as independent of the above-discussed common transport of the oriented spectacle lens semi-finished product together with the positioning retainer. This positioning retainer can thus in principle be arranged to be fixed at a predetermined place and with known orientation at the respective machine or device at or in which the respective main step iii) to vi) is performed. However, this positioning retainer can also be designed to be mobile for the above method. Thus, the positioning retainer—as already mentioned above—can, for example, be mounted in a work or prescription box which is moved back and forth between the individual machines or devices for the main steps ii) to vi). In that regard, the positioning retainer itself can in a particularly simple embodiment be provided, for example, at the base body thereof with a securing bore as well as an orientation groove, a blind bore, or the like, so as to ensure unique positioning and orientation at its respective place of installation (machine, device, job tray, etc.).

The following case of use is an example of use of the proposed positioning retainer independently of the above-discussed transport aspect: Initially, the orientation structures are formed onto the spectacle lens semi-finished product as described above. Transport of the spectacle lens semi-finished product processed by machining or additively is then carried out in known manner and without orientation from the generator to the succeeding machines. The unoriented spectacle lens semi-finished product in a succeeding machine is transported to a simple video station at which the rotational position about the center axis of the spectacle lens semi-finished product is determined on the basis of the orientation structures formed in place. Finally, the spectacle lens semi-finished product is deposited in correct rotational position on the positioning retainer according to the invention, whereby it automatically orientates itself in the remaining degrees of freedom as a consequence of the corresponding interlock, so that position and orientation of the spectacle lens semi-finished product are clearly defined for the further process.

As a result of, in particular, the succeeding “orientation” step in accordance with the invention after provision of the positioning retainer in the proposed method for producing spectacle lenses the invention further provides a combination of a positioning retainer constructed as described above and a spectacle lens semi-finished product, which has in the edge region an orientation structure which is formed in place in accordance with the above method and which mechanically positively engages the positioning structure of the positioning retainer.

In principle, it is possible to (also) form the orientation structure by an additive method at the spectacle lens semi-finished product in that, for example, suitably shaped projections or webs or boundary material for suitably shaped cut-outs are applied to the spectacle lens semi-finished product, for example by printing. However, with respect to, especially, use of subtractive production possibilities already present in any case at most users it is preferred if the orientation structure is formed at the spectacle lens semi-finished product by removal, namely by machining, of material.

In the method mentioned in the introduction for processing of, in particular, spectacle lenses of plastic by machining, which is the subject of the earlier German patent application DE 10 2021 004 831.8 of the same applicant (see, there, in particular the combination of claims 1 and 2), for example, a main step can be provided in which for processing of the front side of the blank by machining by a first tool an encircling groove or step or an encircling cut with an edge contour is formed at the partly processed spectacle lens semi-finished product, which has a slight over-size with respect to an edge contour of the workpiece processed to finished state. In other words, in this form of edge preparation excess material remains in the edge region of the spectacle lens semi-finished product and can be used for formation of the orientation structure. This excess material is removed only when completely at the end of the process chain, after the surface processing procedures, the edge contour of the workpiece processed to finished state is produced. In the interim the excess material at the workpiece provides space for the orientation structure, which advantageously can be formed before, during or after generation of the encircling groove or step or the encircling cut in the course of the older method with the first tool or a further tool.

Moreover, it is preferred particularly with respect to lowest possible outlay in the formation of the orientation structure if the orientation structure has three orientation sections which are formed in an irregular arrangement about a center axis of the spectacle lens semi-finished product. This number and arrangement of orientation sections are sufficient in order to fix the spectacle lens semi-finished product in all six degrees of freedom of movement in three dimensions, namely three mutually independent, i.e. extending at right angles with respect to one another, translational degrees of freedom and three rotational degrees of freedom about three mutually independent axes. Obviously the six degrees of freedom of movement in three dimensions can also be “divided up” to more than three orientation sections of the orientation structure, for example three orientation sections uniformly angularly spaced from one another with respect to the center axis of the spectacle lens semi-finished product plus a further orientation section for also fixing the angular position of the spectacle lens semi-finished product about the center axis, etc., which, however, is less preferred because it is connected with a greater cost.

In equally preferred concrete embodiments the forming of the orientation structure in the edge region of the spectacle lens semi-finished product further comprises forming the individual orientation sections of the orientation structure at positions in the edge region of the front side, in the edge region of the rear side, at the edge, at the transition from the front side to the edge or at the transition from the rear side to the edge of the spectacle lens semi-finished product or distributed to these positions. Expediently, from these positions there is selection—for example for process optimization—for the individual orientation sections of those positions at the spectacle lens semi-finished product which are best able to be reached in the respective sub-step of generating or conversely in the case of presetting of the locations of the individual orientation sections with an already existing positioning retainer that sub-step of the generating in which the respective location is most accessible.

If, for example, application of the orientation structure is carried out when the spectacle lens blank is held at its rear side by a workpiece holding head, such as described in detail in, for example, earlier German patent application DE 10 2021 004 831.8 or earlier German patent application DE 10 2021 005 399.0 of the same applicant, then positions in the edge region of the front side, at the transition from the front side to the edge or at the edge of the spectacle lens semi-finished product are available for formation of the individual orientation sections. If, on the other hand, application of the orientation structure is carried out when the spectacle lens semi-finished product is retained at its front side over the whole area by a workpiece retainer, such as is disclosed in, for example, earlier German patent application DE 10 2021 005 202.1 or also in earlier German patent application DE 10 2021 005 399.0 of the same applicant, then positions in the edge region of the rear side or at the transition from the rear side to the edge of the spectacle lens semi-finished product are available for formation of the individual orientation sections.

In principle, the individual orientation sections of the orientation structure at the spectacle lens semi-finished product are to be formed in such a way that with the assistance of the positioning retainer they enable unambiguous recognition and fixing of location and position of the spectacle lens semi-finished product in three dimensions. Different parameters or features of the individual orientation sections of the orientation structure at the spectacle lens semi-finished product can serve that purpose in conjunction with a respective positioning retainer formed to match. Thus, the individual orientation sections can, for example, lie on different radii with respect to the center axis of the spectacle lens semi-finished product in the edge region thereof, optionally with a uniform angular spacing from one another. However, this would have the consequence of certain limitations concerning the area of the spectacle lens semi-finished product ultimately usable for formation of the edged spectacle lens, so that such an arrangement of the orientation sections at the spectacle lens semi-finished product is appropriate only for specific spectacle lens circumferential shapes. By contrast, an embodiment of the method is preferred—particularly with respect to greatest possible flexibility in use—in which the orientation sections of the orientation structure are formed at the spectacle lens semi-finished product with different geometries and/or with different dimensions and/or with different angular spacings from one another with respect to the center axis of the spectacle lens semi-finished product.

Further, it is conducive to simplest possible formation of the orientation structure if the orientation sections of the orientation structure are preferably formed as grooves—i.e. cut-outs or depressions in the material—or as webs—in the sense of projections or cantilevers—at the spectacle lens semi-finished product. This is possible not only in a removal, for example machining, process as currently preferred, but also in an application, i.e. additive, process. Thus, grooves, as also webs, can be produced by application of groove-bounding or web-forming material. Furthermore, it is possible in simple manner with use of conventional, especially machining, production technologies to remove excess material for formation of the grooves or webs. Moreover, in a special case webs as the orientation structure have a possible advantage by comparison with grooves, namely when the final edge geometry of the spectacle lens is not yet known or lies very close to a prepared edge shape. In such a case there is a risk that introduction of grooves damages the final edge shape.

In the case of, for example, grooves as orientation sections of the orientation structure at the spectacle lens semi-finished product the positioning sections of the positioning structure can be formed at the positioning retainer in an advantageously simple manner by projections which are formed integrally with the base body or attached as pins to the base body. In addition, in correspondence with the respective retaining requirements the projections integrally formed with the base body can in simple manner be pin shaped, although alternatively a web-shaped formation of the projections is also conceivable.

Furthermore, in preferred embodiments of the positioning structure at the positioning retainer the projections forming the positioning sections can be so constructed or arranged that the projections as seen in plan view are arranged to be non-uniformly angularly spaced from one another with respect to the center axis of the base body and/or that the projections project to the same extent from the base body and/or that the projections have a circular cross-section and/or that one of the projections has a slightly larger diameter than the other projections.

A uniform angular spacing of the projections with respect to the center axis of the base body is in fact fundamentally also possible when the unambiguous location and position relationship, which is produced by the mechanically positive couple, between spectacle lens semi-finished product and positioning retainer has been defined by other parameters or features of the projections of the positioning structure or the respectively associated cut-outs of the orientation structure (for example, a further groove or the like for the orientation of the spectacle lens semi-finished product together with a further, associated projection at the positioning retainer). However, the latter would usually be connected with additional cost and accordingly is less preferred. In the case of the non-uniform angular spacing preferred here, for example, three projections could be placed so as to be distributed about the center axis of the base body at 0°, and 90° and 225°.

Although an identical protrusion of the projections of the positioning structure with respect to the base body is preferred, also because this simplifies production of the positioning retainer, it is basically also possible for the projections to be able to project to different extents from the base body so as, for example, to realize a specific tilting of the mechanically positively retained spectacle lens semi-finished product with respect to the positioning retainer. Such a-prismatic-tilting of the spectacle lens semi-finished product can obviously also be produced, when the free length of the projections at the positioning retainer is the same, through the associated cut-outs of the orientation structure in the spectacle lens semi-finished product being formed to be of different depth.

As far as the cross-sectional shape of the projections at the positioning retainer is concerned the circular shape—by comparison with other, equally possible cross-sectional shapes (triangular, rectangular, polygonal, oval, etc.)—is preferred inter alia because the circular shape can be particularly easily realized by, for example, use of commercially available cylindrical pins of steel readily available on the market as standard parts, such pins advantageously being abrasion-resistant and wear-free. Moreover, formation of the respectively associated complementary recess as orientation section of the orientation structure at the spectacle lens semi-finished product can then be carried out particularly quickly and simply by a rotating tool.

Moreover, basically the projections of the positioning retainer can have the same diameter so as to enable, for example, use of identical parts. However, such an embodiment is preferred, particularly with respect to retention as precisely as possible and substantially free of play of the spectacle lens semi-finished product in or at the positioning retainer—such as can be desired or required for specific applications, for example block-free marking—by comparison with the embodiment of the positioning structure already discussed above in which one of the projections has a slightly greater diameter—for example by 0.4 mm—than the other projections.

The orientation structure at the spectacle lens semi-finished product can then be produced, with matching to this diameter of the projections, especially in the above method in simple manner in such a way that the orientation sections, which are formed as grooves, of the orientation structure at the spectacle lens semi-finished product all have an identical clear opening width “dimensionally between” the diameters of the projections. In the combination of spectacle lens semi-finished product and positioning retainer the situation is then that one of the orientation sections, which are formed as grooves, of the orientation structure at the spectacle lens semi-finished product has a clear opening width which is smaller than the diameter of the associated projection at the positioning retainer, whereas the remaining orientation sections, which are formed as grooves, of the orientation structure at the spectacle lens semi-finished product have a clear opening width which is larger than a diameter of the associated projections at the positioning retainer. As a result, the projections with the smaller diameter bear against one contact point in the groove base of the associated groove of the orientation structure, whereas the projection with the greater diameter has two contact points with the orientation structure at the open end of the groove or at the groove edge, which produces a very stable rotational position of the spectacle lens semi-finished product with respect to the center axis of the positioning retainer.

An inversion of the geometric relationships at the grooves of the orientation structure and the projections of the positioning retainer—that is to say, for example, three grooves with different clear opening widths (one smaller, two larger) meeting with three dimensionally identical projections with a diameter dimensionally between these opening widths—is obviously also conceivable for achieving a comparable “position stabilization effect”. However, it is significantly simpler and less susceptible to error to produce a plurality of dimensionally identical grooves at the spectacle lens semi-finished products and to provide a few positioning retainers with projections of different diameter than conversely, for which reason the inverse configuration is less preferred.

In a first alternative of the positioning retainer it can be provided that the projections, which extend obliquely with respect to the center axis of the base body, intersect by the center axes thereof the center axis of the base body and/or that the center axes of the projections include with the center axis of the base body an angle α which is greater than or equal to 30° and smaller than or equal to 60° and/or that the projections by the circumferential surfaces thereof form the positioning sections of the positioning structure for support of the orientation sections of the orientation structure at the respective spectacle lens semi-finished product.

The projections of the positioning structure in that case are preferably inclined in three dimensions only to such an extent that the center axes of the projections intersect the center axis of the base body of the positioning retainer, more preferably at a common point. Neither the intersection of the afore-mentioned center axes in themselves nor the meeting of the center axes at a common point is necessary at the positioning retainer, but it simplifies the machine kinematics and mathematics of the tool path control needed for formation of the orientation sections at the spectacle lens semi-finished product.

Expediently, the angle α which best matches the geometry and dimensions of the spectacle lens semi-finished products usually to be processed is selected from the mentioned region of the (inclination) angle α (30° to) 60° between the center axes of the projections and the center axis of the base body. Thus, in the case of spectacle lens semi-finished products with very different diameters the angle α should not be too small (“steep” positioning retainer) because this would restrict the retention possibilities of the positioning retainer to rather fewer and rather smaller-diameter spectacle lens semi-finished products. For example, coverage of a diameter range of the spectacle lens semi-finished products of typically 50 to 80 mm would be desirable here. On the other hand, however, the angle α should also not be too large (“flat” positioning retainer) because this could create problems in the case of strongly curved spectacle lens semi-finished products with large opening angles, since these could not then be retained at the projections of the positioning retainer in the edge region where the orientation structure is formed and instead there would be a risk of radially further inwardly lying surface contact of the spectacle lens semi-finished product with the projections of the positioning retainer. In this area of clamping the claimed range of 30° to 60° for the angle α was found by the inventors to be a good compromise.

Moreover, the individual projections of the positioning retainer can also include, by the center axes thereof, mutually different angles α with the center axis of the base body, but particularly for the reasons already mentioned above—complex machine kinematics and complicated mathematics of the tool path control for the formation of the orientation structure at the spectacle lens semi-finished product—this is less preferred.

At this point it may also be mentioned that the inclined or obliquely extending projections of the positioning retainer as seen in a plan view along the center axis of the base body can either extend radially outwardly from a central base body or, however, radially inwardly from a base body, which has for the obliquely extending projections attachment or fastening points arranged substantially on a notional circle about a center axis of the positioning retainer. In the latter case the base body can have, for example, webs which are distributed at equal or unequal angular spacings from one another about the center axis of the positioning retainer similarly to the points of a crown and at which the said attachment or fastening points for the projections are provided. One such base body or several such base bodies can, in particular, also be an integral component of a work or prescription box for the orientated transport of the spectacle lens semi-finished products or, however, a fixed component of a processing device, depending on the respective use of the positioning retainer.

In the combination of positioning retainer and spectacle lens semi-finished product the (inclination) angle α of the center axes of the projections relative to the center axis of the base body of the positioning retainer has yet a further significance: If the orientation sections which are preferably formed as grooves, of the orientation structure at the spectacle lens semi-finished product each have a substantially straight groove base—which is also preferred—including an angle β with the center axis of the base body of the positioning retainer then the latter angle should preferably be different from the angle α which the obliquely extending projections of the positioning retainer include with the center axis of the base body. In that case the difference of the angle β from the angle α should preferably be between 2° and 40° and more preferably between 5° and 15°, as found by the inventors.

An advantageous effect of this optional difference in angle includes the fact that there is not lineal contact, but a point contact between the respective groove of the orientation structure at the spectacle lens semi-finished product and the associated projection of the positioning structure at the positioning retainer. Such a point contact is then present only at one longitudinal end of the straight groove or at the other longitudinal end thereof, depending on whether the angle α is greater or smaller than the angle β. If the angle α is greater than the angle β then this point contact between the spectacle lens semi-finished product and positioning retainer is present radially inwardly at the orientation structure, which can be advantageous in the case of spectacle lens semi-finished products having a rather thin edge, for example so-called “plus lenses” (lens thickness decreases towards the edge). On the other hand if the angle α is smaller than the angle β then that point contact lies radially outwardly at the orientation structure, which is appropriate in the case of spectacle lens semi-finished products with a rather thick edge, for example so-called “minus lenses” (lens thickness increases towards the edge). Ultimately, this point contact is in turn conducive to especially accurate and clear contact of the orientation structure of the spectacle lens semi-finished product with the positioning structure of the positioning retainer.

In a further alternative, which is particularly suitable for orientated transport of the spectacle lens semi-finished product, of the positioning retainer with projections as positioning sections of the positioning structure it can also be provided that the projections extend by the center axes thereof substantially parallel to the center axis of the base body away from one end face of the base body and form by the free ends thereof the positioning sections of the positioning structure and/or that the projections are formed at their free ends to be spherically domed.

Such a “parallel” alternative of the positioning retainer with projections is particularly suitable for a case in which the individual orientation sections of the orientation structure (must) lie at positions in the edge region of the front side or in the edge region of the rear side of spectacle lens semi-finished product, for example because the edge of the spectacle lens semi-finished product is comparatively thin and/or sensitive to breakage. In order to be able to retain spectacle lens semi-finished products with different outer diameters the individual projections may then also be designed to be adjustable in radial direction with respect to the center axis of the base body, as already mentioned further above.

In principle, in this case the free ends of the parallel projections of the positioning retainer can, for mechanically and positive engagement with the, for example, prismatically formed orientation sections of the orientation structure at the spectacle lens semi-finished product, be formed to be, for example, conical or pointed so as to produce point contact at the respective engagement location between positioning section and orientation section. However, by comparison with such a possible embodiment of the engagement situation it is preferred if the free ends of the projections are of spherically domed configuration. This advantageously leads, in the combination of positioning retainer and spectacle lens semi-finished product with, for example, prismatically shaped orientation sections of the orientation structure, in every case at one of the projections to two-point contact with the associated orientation section at the spectacle lens semi-finished product, whereas at the other projections of the positioning retainer—due to production tolerances—there is single-point contact with the corresponding orientation section of the spectacle lens semi-finished product. Thus, in the case of this embodiment, as well, the engagement situation already described further above can arise, in which there are two contact points with the orientation structure of the spectacle lens semi-finished product at one of the projections of the positioning retainer and in each instance one contact point with the orientation structure at each of the other projections, which in turn produces a very stable rotational position of the spectacle lens semi-finished product with respect to the center axis of the positioning retainer.

In both of the afore-described alternatives of the positioning retainer—with projections either inclined or parallel with respect to the center axis of the base body—provision can be further made for the base body to be formed annularly or hollow-cylindrically with a central passage about the center axis. An advantage of such a design of the positioning retainer includes particularly the fact that by way of the central passage there can be engagement by a die or the like at one of the sides of the positioned and aligned spectacle lens semi-finished product, while on the opposite side of the spectacle lens semi-finished product, for example, a mating die engages so as to hold the spectacle lens semi-finished product in or for one of the further main steps iii) to vi). For the actual processing procedure—for example edge processing by machining (edging) in the further main step vi)—the positioning retainer can then be moved away in the direction of its center axis from the spectacle lens semi-finished product over the die or the mating die—or conversely the spectacle lens semi-finished product held between the dies away from the positioning retainer or both—so as to enable tool engagement at the spectacle lens semi-finished product now held in defined manner in three dimensions.

Moreover, in a further alternative of the method it can be provided in correspondence with the respective requirements of subsequent processes and/or of workpiece transport between the individual processing procedures that the main step ii) of generating comprises a further sub-step in which a holding structure is formed in the edge region of the spectacle lens semi-finished product, wherein after the mechanically positive alignment of the spectacle lens semi-finished product with the positioning retainer the spectacle lens semi-finished product is held at the positioning retainer with the help of the holding structure, while the further processing or transport of the spectacle lens semi-finished product takes place. As a result, holding of the spectacle lens semi-finished product in the desired or required position and with the respectively associated orientation is also possible in particularly simple manner in the processing steps following the generating or therebetween.

In adaptation thereto the positioning retainer can optionally be provided with the holding arrangement which is adapted to engage the spectacle lens semi-finished product, particularly the holding structure at the spectacle lens semi-finished product, so as to hold the spectacle lens semi-finished product with its orientation structure in mechanically positive engagement with the positioning structure at the positioning retainer. A holding arrangement according to a union nut principle is, for example, conceivable here.

In addition, an embodiment is possible in which the holding arrangement comprises a lever which is articulated at one end to the base body of the positioning retainer and is provided at its other, free end with a weight. Moreover, this lever can be designed and dimensioned in such a way that in a lowered or pivoted-down state it engages by its free end at a central point of a spectacle lens semi-finished product, which is retained in the positioning retainer, so as to keep the correspondingly “weighted” spectacle lens semi-finished product in mechanically positive engagement thereof with the positioning retainer. In order to avoid damage to the spectacle lens semi-finished product the free end of the lever can in that case be provided at its end facing the spectacle lens semi-finished product with a suitable cushioning of foam material or the like.

If such a holding arrangement together with the positioning retainer is integrated in a job tray or prescription box then the lever can also be constructed as, for example, a bell crank with one limb for “weighting” the spectacle lens semi-finished product from above during transport, as described above, and a further limb for movement control of the bell crank lever. In that case the further limb can, for example, be provided with a control pin or the like which co-operates with a guide lying outside the workbox so as to automatically pivot the bell crank lever out of its position “weighting” the spectacle lens semi-finished product when the workbox during transport thereof through the finishing facilities approaches a position at which the spectacle lens semi-finished product retained in the positioning retainer is to be removed from the positioning retainer—suitably positioned and orientated—for the further process. In analogous manner the “weighting” of a spectacle lens semi-finished product, for example by a guide-controlled bell crank as described, just inserted into the positioning retainer can be automated.

In another concrete embodiment the optional holding arrangement at the positioning retainer can comprise a plurality of holding down devices, for example two or—with a view to static definition of the arrangement—preferably three downholders, which with respect to the center axis of the base body of the positioning retainer are expediently arranged to be distributed at the base body at angular spacings from one another and/or are pivotably articulated to the base body of the positioning retainer and/or are formed to be angled.

Obviously other shapes of the movable arrangement of the downholders at the base body, for example with the assistance of a linear guide arrangement oriented radially with respect to the center axis of the base body, are conceivable and/or a different geometry of the downholders, for example U-shaped or C-shaped, albeit at present less preferred.

Finally, in the combination of a spectacle lens semi-finished product, which is provided with the afore-mentioned holding structure, and a positioning retainer, which is furnished with a holding arrangement formed to be complementary with the holding structure of the spectacle lens semi-finished product, the holding arrangement can mechanically positively engage the holding structure so that the spectacle lens semi-finished product is securely held at the positioning retainer. The thus-held spectacle lens semi-finished product can now be further processed as desired or required and/or transported between the individual processing steps with security against loss. The embodiment with the holding structure or holding arrangement in addition advantageously avoids the risk of “slipping” during the transport, in the case of which at least the defined position and orientation at the spectacle lens semi-finished product would be lost. As with the orientation structure, the holding structure optionally formed at the spectacle lens semi-finished product is only a temporary geometry, which in the last main step vi) of production of the spectacle lens, i.e. during formation of the frame shape of the spectacle lens, is entirely removed, unless it can—at least partly—also be used as, for example, a shoulder or step for the purpose of securing the finished spectacle lens in the spectacles frame.

Further features, characteristics and advantages of the method according to the invention, the positioning retainer according to the invention and the combination according to the invention of such a positioning retainer and a spectacle lens semi-finished product prepared particularly in the course of the method according to the invention will be evident to the person ordinarily skilled in the art from the following description of preferred embodiments.

### BRIEF DESCRIPTION OF THE DRAWINGS

The invention is explained in detail in the following on the basis of preferred embodiments with reference to the accompanying, partly schematic drawings, in which the same or corresponding parts or sections are provided with the same reference numerals, in a given case supplemented by superscript dashes (′) or (″) so as to indicate that different embodiments or variants are concerned. In the drawings:

FIG. 1 shows a flow chart of a process chain for producing spectacle lenses according to a general embodiment of the invention, wherein the process chain manages without the necessity of use of blocking members for the production and in the initiating process of “block-free generating” comprises a sub-step in which an orientation structure, which serves for fixing or establishing location and position of the workpiece in three dimensions for or in the following process or processes, is applied to the workpiece;

FIG. 2 shows a perspective view of a workpiece holding head of a processing device at which a spectacle lens semi-finished product as workpiece is retained at its rear side without blocking and is held in supported manner, while in accordance with a concrete first embodiment of the invention the orientation structure is formed on the workpiece at the transition from the front side to the edge of the workpiece by a rotationally driven end mill, wherein those body edges which can be seen only through the transparent workpiece are illustrated by dashed lines;

FIG. 3 shows an enlargement of the detail Ill in FIG. 2 without the body edges covered by the workpiece, the enlargement illustrating a groove as one of three orientation sections of the orientation structure formed on the spectacle lens semi-finished product in accordance with FIG. 2;

FIG. 4 shows a perspective view of a positioning retainer for a spectacle lens semi-finished product particularly for use in a method according to the invention for producing spectacle lenses, with a positioning structure adapted to the orientation structure, which according to FIG. 2 is formed on the spectacle lens semi-finished product, in accordance with the concrete first embodiment;

FIG. 5 shows a plan view of the positioning retainer according to FIG. 4 from above in FIG. 4, which illustrates that three positioning sections of the positioning structure are formed by pins which project from a base body and extend at an inclination and which are arranged at a non-uniform angular spacing from one another with respect to a center axis of the base body;

FIG. 6 shows a perspective view of a combination of the positioning retainer of FIG. 4 and a spectacle lens semi-finished product which has a comparatively large diameter and which comprises an orientation structure formed in place in accordance with FIG. 2 and mechanically positively engaging the positioning structure at the positioning retainer, wherein again those body edges which can be seen only through the transparent material are illustrated by dashed lines;

FIG. 7 shows a perspective view, which is similar to FIG. 6, of a combination of the positioning retainer of FIG. 4 and a spectacle lens semi-finished product, which has a comparatively small diameter and which again comprises an orientation structure formed in correspondence with FIG. 2 and mechanically positively engaging the positioning structure at the positioning retainer, again with the body edges covered by the workpiece in dashed lines;

FIG. 8 shows a perspective view of a combination of the positioning retainer according to FIG. 4, in which one of the pins, which form the positioning sections, of the positioning structure has a greater diameter than the remaining pins—which for better illustration is depicted substantially exaggerated in size in FIG. 8 at top right with a perspective view of the thicker pin—and a spectacle lens semi-finished product with relatively large diameter, which comprises an orientation structure formed in correspondence with FIG. 2 and having dimensionally identical orientation sections and which mechanically positively engages the positioning structure at the positioning retainer, with a viewing direction along the center axis of one of the pins of smaller diameter and again with the body edges covered by the workpiece in dashed lines;

FIG. 9 shows an enlargement of the detail IX in FIG. 8, which shows how one of the pins of smaller diameter of the positioning structure of the positioning retainer bears at one point against the groove base of the orientation section, which is formed as a groove, of the orientation structure at the spectacle lens semi-finished product;

FIG. 10 shows a perspective view of the combination according to FIG. 8, which by comparison with the illustration in FIG. 8 is rotated about the center axis of the base body of the positioning retainer in such a way that the viewing direction lies along the center axis of the pin of greater diameter;

FIG. 11 shows an enlargement of the detail XI in FIG. 10, which clarifies how the pin of greater diameter of the positioning structure of the positioning retainer bears at two positions against the groove edge of the orientation section, which is formed as a groove, of the orientation structure at the spectacle lens semi-finished product in order to stabilize the rotational position of the spectacle lens semi-finished product about the center axis of the base body of the positioning retainer;

FIG. 12 and FIG. 13 show, in an image detail similar to FIGS. 8 and 9 or 10 and 11, details to enlarged scale of a combination of positioning retainer and spectacle lens semi-finished product with orientation sections, which are formed as grooves, of the orientation structure, wherein the details illustrate-again in a depiction substantially exaggerated in terms of dimension-on the basis of a combination variant how with the same pin diameter of the positioning retainer a pin contact at one place at the groove base of the orientation section (FIG. 12) or at two places at the groove edge of the orientation section (FIG. 13) can be produced through the orientation sections, which are formed as grooves, of the orientation structure at the spectacle lens semi-finished product having different geometries or different dimensions;

FIG. 14 shows a perspective sectional view of the combination of positioning retainer and spectacle lens semi-finished product according to FIG. 8 in correspondence with the section line XIV-XIV in FIG. 8;

FIG. 15 shows an enlargement of the detail XV in FIG. 14 for illustration of an angle difference between the angles α and B, which a center axis of a pin of the positioning retainer and a straight groove base of an orientation section of the spectacle lens semi-finished product respectively include with the center axis of the base body of the positioning retainer, wherein this angle difference leads to local point contact between the orientation structure at the spectacle lens semi-finished product and the positioning structure at the position retainer;

FIG. 16 shows a perspective view of a workpiece holding head of a processing device at which a spectacle lens semi-finished product, as workpiece, is retained by its rear side in block-free manner and held in supported manner, wherein in accordance with a concrete second embodiment of the invention a different orientation structure is formed at the workpiece in the edge region of the front side of the workpiece by a rotationally driven end mill and wherein again those body edges which can be seen only through the transparent workpiece are illustrated by dashed lines;

FIG. 17 shows an enlargement of the detail XVII in FIG. 16 without the body edges covered by the workpiece, the enlargement illustrating a groove, which differs from the groove corresponding with FIG. 3, as one of three orientation sections of the orientation structure formed at the spectacle lens semi-finished product in accordance with FIG. 16;

FIG. 18 shows a perspective view of a positioning retainer for a spectacle lens semi-finished product for use in a method according to the invention for producing spectacle lenses with a positioned and oriented transport of the spectacle lens semi-finished product, wherein the positioning retainer serving for that purpose is provided with a different positioning structure which is adapted to the orientation structure—which is formed at the spectacle lens semi-finished product in accordance with FIG. 16—according to the concrete second embodiment and comprises, as positioning sections, projections having center axes extending substantially parallel to the center axis of a base body, which here is annular;

FIG. 19 shows a perspective view of a combination of the positioning retainer according to FIG. 18 and a spectacle lens semi-finished product having an orientation structure which is formed in accordance with FIG. 16 and which mechanically positively engages the positioning structure at the positioning retainer, wherein again those body edges which can be seen only through the transparent workpiece are illustrated by dashed lines;

FIG. 20 shows a side view of a combination of a positioning retainer according to FIG. 18 and a (thinner) spectacle lens semi-finished product similar to FIG. 19, with a central view of one of the positioning sections of the positioning retainer, against which an associated orientation section of the spectacle lens semi-finished product mechanically positively bears, wherein in a lower region of the positioning retainer a central die, which extends into the annular base body of the positioning retainer, for holding the spectacle lens semi-finished product is indicated and wherein again those body edges which can be seen only through the transparent workpiece are illustrated by dashed lines;

FIG. 21 shows a sectional view of the combination of positioning retainer and spectacle lens semi-finished product according to FIG. 20 in correspondence with the section line XXI-XXI in FIG. 20;

FIG. 22 shows an enlargement of the detail XXII in FIG. 20 for illustration of the mechanically positive engagement between the pin-like positioning section, which is provided with a spherically domed end, of the positioning retainer and the orientation section, which is configured in the form of a prismatic groove, of the spectacle lens semi-finished product;

FIG. 23 shows a longitudinal sectional view of a spectacle lens semi-finished product with an orientation structure corresponding with FIGS. 16 and 17, which after positioning and alignment with the assistance of the positioning retainer according to FIG. 18 is held between the die of FIG. 20 and a mating die for formation of a frame shape by an end mill, which is also shown, wherein—as in FIG. 21—a cross-hatching characterizes that material of the spectacle lens semi-finished product which in the course of formation of the frame shape is removed together with the orientation structure from the central remainder of the workpiece;

FIG. 24 shows a perspective view of a workpiece holding head of a processing device at which a spectacle lens semi-finished product as workpiece is retained at its rear side blocklessly and is held in supported manner, wherein in accordance with a concrete third embodiment of the invention in addition to the orientation structure and similarly to FIGS. 16 and 17 a holding structure is formed at the edge of the workpiece by a rotationally driven end mill and wherein again those body edges which can be seen only through the transparent workpiece are illustrated by dashed lines;

FIG. 25 shows a perspective view of a combination of the spectacle lens semi-finished product according to FIG. 24 and a positioning retainer similar to FIG. 18, which is additionally provided with a holding arrangement, which comprises a downholder and which mechanically positively engages the holding structure at the spectacle lens semi-finished product so that the spectacle lens semi-finished product is held by its orientation structure in mechanically positive engagement with the positioning structure at the positioning retainer, wherein dashed lines again indicate those body edges which can be seen through the transparent workpiece;

FIG. 26 shows a perspective view of a variant of a spectacle lens semi-finished product which in the course of block-free generation in the method according to the invention undergoes preliminary edge processing in which cut-outs at the edge side were conjunctively formed as orientation sections of an orientation structure for following steps; and

FIG. 27 shows a perspective view of a further variant of a spectacle lens semi-finished product which during block-free generation in the method according to the invention has undergone preliminary edge processing in which the projections at the edge side as orientation sections of an orientation structure for following steps were conjunctively formed.

### DETAILED DESCRIPTION OF THE EMBODIMENTS

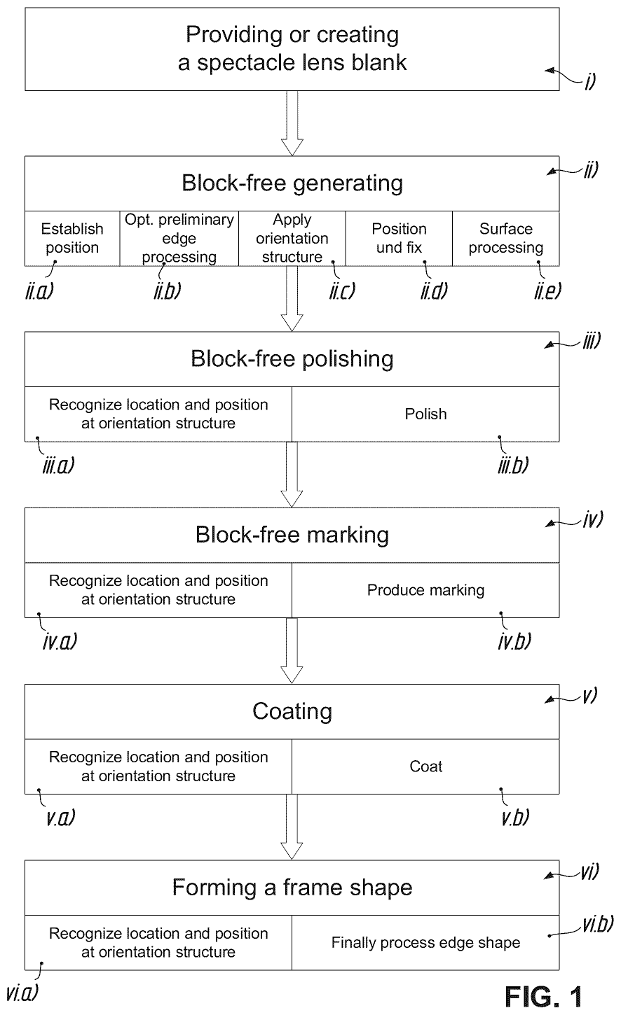

FIG. 1 shows a flow chart of a process chain for production of spectacle lenses, in particular of plastics material, without use of blocking members in production, wherein by comparison with the conventional procedure the auxiliary processes of “blocking” and “deblocking” are eliminated. In the course of this process chain and beginning with a spectacle lens blank via a spectacle lens semi-finished product a spectacle lens finished part is produced by removal and/or application of material, generally denoted in the following and in the drawings—regardless of the respective degree of processing of the workpiece—by the reference numeral 10 for a spectacle lens. In that case, the spectacle lens 10 is formed with predetermined surface geometries at two sides 12 and 14, namely a front side 12 and a rear side 14 remote therefrom, and with a contoured edge 16 between the two sides 12, 14. The qualifications “front” and “rear” here refer to the later position of installation of the spectacle lens 10 in a spectacles frame, with the front side 12 facing the eye and the rear side 14 remote from the eye.

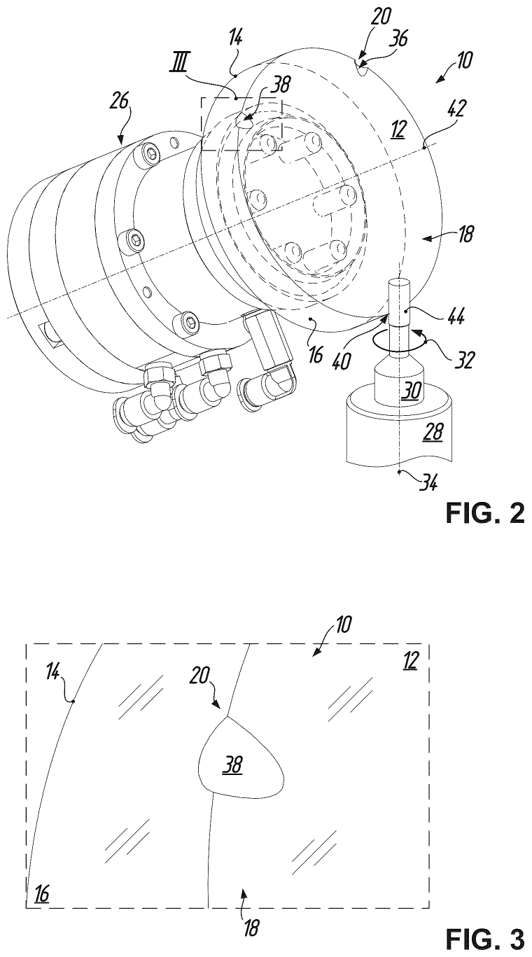

As already described in the introduction, the method for producing spectacle lenses 10 comprises, according to FIG. 1, generally i) provision or creation of the spectacle lens blank, which is to be processed at at least one of its (end) sides 12, 14 as well as at the edge 16 therebetween, and ii) generation of an optically active form of the spectacle lens 10 by removal and/or application of material on at least one of the sides 12, 14 of the spectacle lens blank for formation of the spectacle lens semi-finished product, which has an edge region 18 (see, for example, FIG. 2) of (spectacle lens) material near the edge 16, as initiating essential main steps of the production. In correspondence with the respective processing requirements for each spectacle lens 10 to be produced these main steps i) and ii) are necessarily followed by at least one further main step—in the present general embodiment all main steps—from a group of main steps iii) to vi), comprising the main steps of: iii) block-free polishing of the spectacle lens semi-finished product at at least one of the sides 12, 14 for reducing surface roughness; iv) block-free marking of the spectacle lens semi-finished product with a permanent marking at at least one of the sides 12, 14; v) coating of the spectacle lens semi-finished product for enhancement of workpiece quality at at least one of the sides 12, 14; and vi) forming a frame shape of the spectacle lens 10 by removal and/or application of (preferably spectacle lens) material in the edge region 18.

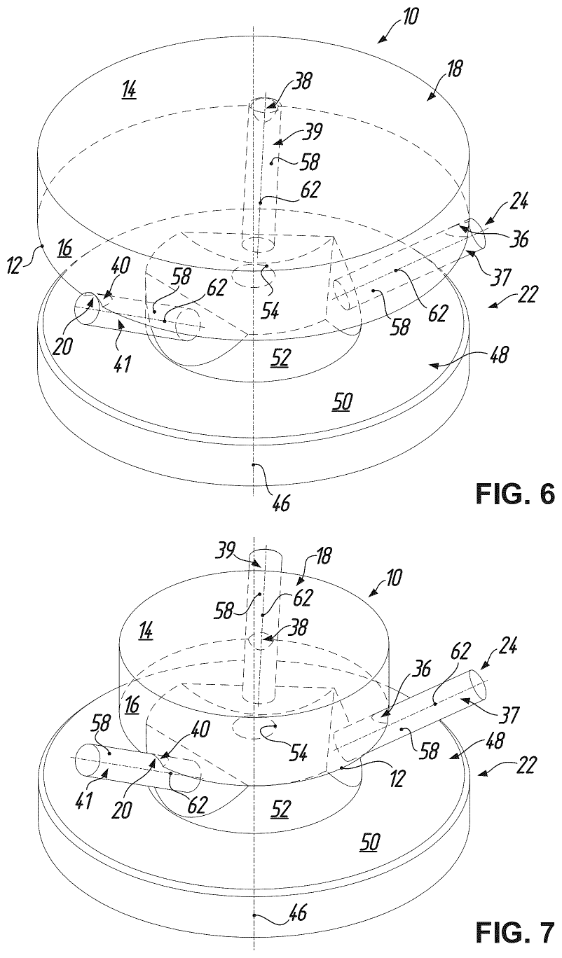

Significant features, which are still to be explained in more detail in the following, of this production in that regard are that firstly the main step ii) of generating comprises according to FIG. 1 a sub-step ii.c) in which an orientation structure 20 (cf. again, for example, FIG. 2) is formed in the edge region 18 of the spectacle lens semi-finished product. Secondly, the method comprises a following step which is not explicitly referred to in FIG. 1 and in which there is provided a positioning retainer 22 (see, for example, FIGS. 6 and 7) which is positionable in three dimensions in defined manner and is described in more detail in the following in different variants and with the help of which the location and position of the spectacle lens semi-finished product in three dimensions are unambiguously recognized and fixed. For that purpose the positioning retainer 22 has a positioning structure 24, with which the spectacle lens semi-finished product is aligned by mechanically positive couple by its orientation structure 20 in the edge region 18. Thirdly, the spectacle lens semi-finished product, which is retained at the positioning receptacle 22 with positioning and orientation in that way, together with the positioning retainer 22 is transported for further processing in at least one of the further main steps iii) to vi) in which re-establishing of the location and position of the spectacle lens semi-finished product is unnecessary. This is because the location and position of the spectacle lens semi-finished product are known by way of the orientation structure 20 which is applied thereto and which mechanically positively engages the positioning structure 24 of the conjunctively transported positioning retainer 22. At the start of the respective further main step from the group of main steps iii) to vi) a spectacle lens semi-finished product thus positioned and orientated in defined manner is present so that the location and position thereof are recognizable without further measures, as indicated in FIG. 1 at iii.a), iv.a), v.a) or vi.a) of the respective main step iii) to vi).

As far as the further individual sub-steps of the process chain according to FIG. 1 are concerned reference may first of all be made at this point—with respect to the sub-steps ii.a) to ii.e) of the main step ii) of generating—by way of example, but expressly, to the afore-mentioned earlier German patent applications of the same applicant, which disclose possible—but not obligatory—method embodiments. Thus, for example, details with respect to the sub-step ii.a) of fixing the position of the spectacle lens blank in FIG. 1 can be inferred particularly from earlier German patent application DE 10 2021 005 399.0. Earlier German patent application DE 10 2021 004 831.8 is concerned in detail with special embodiments of the sub-step ii.b) of preliminary edge processing according to FIG. 1, insofar as this is provided. Positioning and fixing of the spectacle lens semi-finished product according to the sub-step ii.d) in FIG. 1 are (inter alia) the subject of earlier German patent application DE 10 2021 005 202.1. All three earlier German patent applications contain further details with respect to surface processing in accordance with the sub-step ii.e) in FIG. 1. Finally, one possible mode and manner of handling the workpiece between the individual sub-steps ii.a) to ii.e) can also be inferred from, in particular, earlier German patent application DE 10 2021 005 399.0.

The actual processing sub-steps iii.b) of polishing, iv.b) of marking, v.b) of coating and vi.b) of final edge processing of the further main steps iii) to vi) were already briefly outlined further above, but are in any case familiar to the person ordinarily skilled in the art and do not require at this point more detailed explanation for an understanding of the present invention.

Details with respect to the sub-step ii.c) of application of the orientation structure 20 in the main step ii) of generating without a blocking member in the first embodiment can now be inferred from FIGS. 2 and 3. In the first instance, there is to be seen in FIG. 2 the spectacle lens semi-finished product 10 which is held in supported manner at a workpiece holding head 26 suitably movable in three dimensions. The workpiece holding head 26 and also suitable mechanisms for moving the workpiece holding head 26 in three dimensions are described in detail in earlier German patent application DE 10 2021 005 399.0, to which express reference is again made with regard to relevant details.

On the tool side there is indicated in FIG. 2 in broken-away form a milling spindle 28 by which an end mill 30 also illustrated merely schematically—in particular without cutters—can be rotationally driven about a center axis 34 in correspondence with the movement arrow 32 in FIG. 2. The milling spindle 28 can be arranged to be stationary at or in a generator (not shown) or, however, movable at a suitable movement mechanism of the generator so as to execute relative movements between the workpiece holding head 26 and the milling spindle 28 during processing. In FIG. 2 the end mill 30 is just in processing engagement with the spectacle lens semi-finished product 10 so as to form the orientation structure 20 at the spectacle lens semi-finished product 10 by removal, namely by machining, of spectacle lens material.

The forming of the orientation structure 20 at the spectacle lens semi-finished product 10 is carried out in the embodiment illustrated in FIG. 2 with an angular approach of the center axis 34 of the end mill 30 relative to the center axis 42 of the workpiece holding head 26 and thus the spectacle lens semi-finished product 10 held thereat. However, it will be evident to the person ordinarily skilled in the art that this does not have to be the case. Thus, for example, the center axes 34 and 42 of the end mill 30 and the spectacle lens semi-finished product 10, respectively, can also extend parallel to one another, in which case a corresponding geometry of the respective orientation section 36, 38, 40 at the spectacle lens semi-finished product 10 is produced through the workpiece 10 and/or tool 30—which both have two mutually perpendicular linear axes—being moved relative to one another. Whereas in that case one linear axis produces a movement along the center axes 34, 42, the other linear axis ensures movement perpendicular to the center axes 34, 42. In the case of, for example, the same speeds of advance of the two linear axes the milling edge then moves between the circumferential and end cutters of the end mill 30 at 45° with respect to the center axes 34, 42, which can be used for producing geometry.

In the illustrated embodiment the orientation structure 20 at the spectacle lens semi-finished product 10 is produced with three orientation sections 36, 38, 40 formed in an irregular arrangement about a center axis 42 of the spectacle lens semi-finished product 10. More precisely, in this embodiment the orientation sections 36, 38, 40 are placed at the circumference of the spectacle lens semi-finished product 10 with distribution to the angular positions 0°, 90°, and 225° about the center axis 42, i.e. at the spectacle lens semi-finished product 10 with different angular spacings from one another with respect to the center axis 42 of the spectacle lens semi-finished product 10 and, in particular, at positions at the transition from the front side 12 to the edge 16 of the spectacle lens semi-finished product 10.

In this embodiment the orientation sections 36, 38, 40, which in themselves are formed to be identical with respect geometry and dimensions, of the orientation structure 20 are produced only by the milling cutters (not shown) arranged at the outer circumference 44 of the end mill 30. In that case the orientation sections 36, 38, 40 are each formed as a groove, the groove wall of which is formed from the flat shape to be curved or hollow-cylindrical in correspondence with the cylindrical envelope curvature at the outer circumference 44 of the end mill 30, as the enlargement according to FIG. 3 shows.

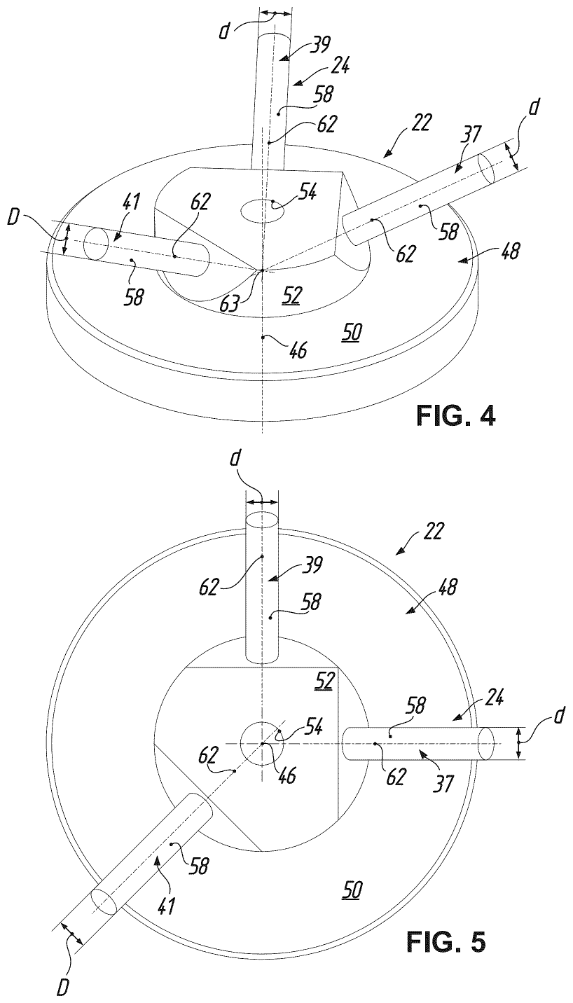

FIGS. 4 and 5 now show the positioning retainer 22 for the spectacle lens semi-finished product 10 for use in the above method for producing spectacle lenses in accordance with the first embodiment. The positioning retainer 22 comprises in general a base body 48 which has a center axis 46 and which carries the positioning structure 24. In this embodiment, in correspondence with the orientation structure 20 at the spectacle lens semi-finished product the positioning structure 24 has three positioning sections 37, 39, 41 for the spectacle lens semi-finished product 10, which are placed in irregular arrangement about the center axis 46. In that case the positioning structure 24 of the positioning retainer 22 has overall a geometry with which the orientation structure 20 at the spectacle lens semi-finished product 10 is formed to match so that by virtue of a mechanically positive couple between the positioning structure 24 at the positioning retainer 22 and the orientation structure 20 at the spectacle lens semi-finished product 10, as illustrated in, for example, FIGS. 6 and 7, the location and position of a spectacle lens semi-finished product 10, which is retained at the positioning retainer 22, with respect to the base body 48 are unambiguously and clearly defined.

In accordance with, in particular, FIGS. 4, 5 and 14 the base body 48 of the positioning retainer 22 has a plate-shaped base 50, away from which a step 52 extends at a central position along the center axis 46. As the longitudinal section according to FIG. 14 shows, a securing bore 54, which in the illustrated embodiment has the configuration of a passage bore, also extends along the center axis 46 and through the base 50 and the step 52. The positioning retainer 22 can be mounted with the help of this securing bore 54 at a fixed position of a processing machine, of a work box (“job tray”), etc. (not shown), for example by a securing screw (also not shown) engaging through the securing bore 54. An orientation cut-out 56 which in accordance with FIG. 14 is executed as, for example, a blind bore can in that case in co-operation with a dowel pin or the like (not illustrated) at the processing machine, the job tray, etc., ensure a defined angular orientation of the positioning retainer 22 about the center axis 46.

As can also be clearly seen in FIGS. 4, 5 and 14, in this embodiment the positioning sections 37, 39, 41 of the positioning structure 24 at the positioning retainer 22 are in addition formed by projections 58, which here are applied to the base body 48 as (cylindrical) pins with a circular cross-section. More precisely, the step 52 of the base body 48 is, as shown in FIG. 14, provided with obliquely extending securing bores 60, which extend inwards from radially outwardly up to the central securing bore 54 of the base body 48 and serve for reception of the pins. In the case of, in particular, a metallic construction of the base body 48 and of the pins forming the projections 58 the pins can, for example, be pressed into the securing bores 60 with a press fit. As a result, the projections 58 secured to the base body 48 form by the circumferential surfaces thereof the positioning sections 37, 39, 41 of the positioning structure 24, as, in particular, FIGS. 6 and 7 also show.

As can be best seen in the plan view of the positioning retainer 22 according to FIG. 5 the projections 58 are in addition arranged at non-uniform angular spacings from one another with respect to the center axis 46 of the base body 48. More precisely, in order to match the orientation structure 20 at the spectacle lens semi-finished product 10 the projections 58, which form the positioning structure 24, of the positioning retainer 22 are placed—beginning with the projection 58 on the right in FIG. 5—at the angular positions 0°, 90° and 225° in counter-clockwise sense about the center axis 46 of the base body 48. FIG. 5 also shows that the projections 58 project to the same extent from the base body 48, which applies not only with respect to the center axis 46 in radial direction in correspondence with the plan view according to FIG. 5, but also in height direction as seen along the center axis 46 of the positioning retainer 22.

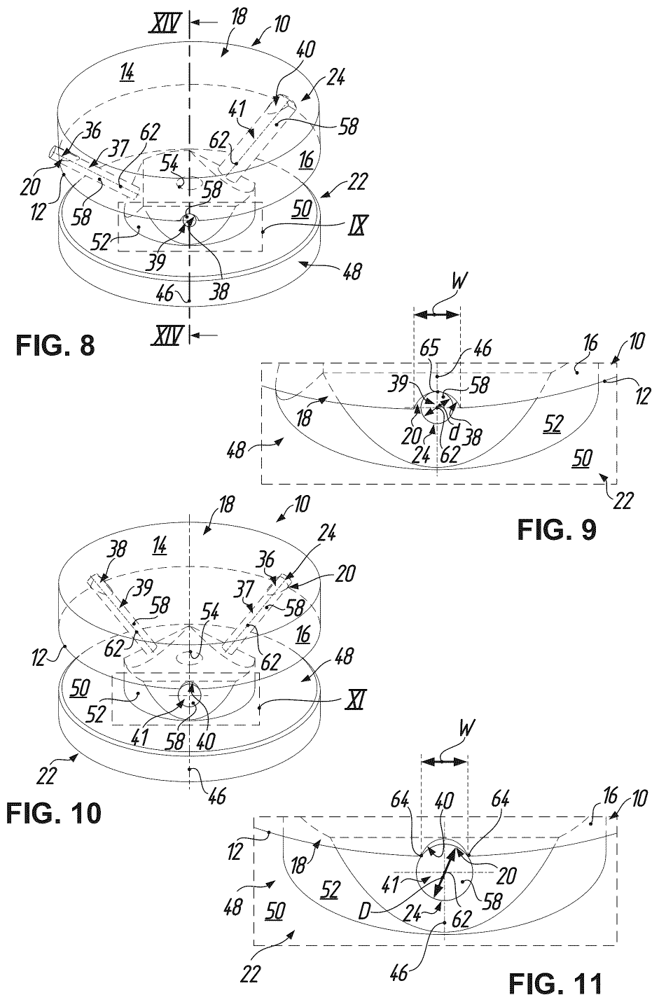

Moreover, it is already indicated in FIGS. 4 and 5 that one of the projections 58 (at bottom left in these figures) has a slightly larger diameter D than the other projections 58, which have, for example, a diameter d smaller by 0.4 mm. The effect of this size difference is still explained in the following on the basis of FIGS. 8 to 11, which illustrate the difference in diameter of the projections 58 with substantial exaggeration in size.

Finally, FIGS. 4 and 5 also show that the projections 58 of the positioning retainer 22 extend obliquely with respect to the center axis 46 of the base body 48—in correspondence with the securing bores 60—and by the center axes 62 thereof intersect the center axis 46 of the base body 48, here at a common point 63 (see FIGS. 4 and 14). In that case the center axes 62 of the projections 58 include with the center axis 46 of the base body 48 according to FIGS. 14 and 15 an angle α which is greater than or equal to 30° and smaller than or equal to 60°, and in the illustrated embodiment lies closely below 60°.

The effect of this oblique setting of the projections 58 with respect to the center axis 46 of the base 48 is illustrated in FIGS. 6 and 7, which each show a combination of the positioning retainer 22 according to FIGS. 4 and 5 with a spectacle lens semi-finished product 10, which has in the edge region 18 an orientation structure 20 which is formed in correspondence with FIGS. 2 and 3 and which is in engagement with the positioning structure 24 of the positioning retainer 22 by mechanically positive couple so as to bring the spectacle lens semi-finished product 10 at the positioning retainer 22 into a clearly defined position and orientation. Through, in particular, the inclined setting of the projections 58 forming the positioning sections 37, 39, 41 of the positioning structure 24 it is possible to retain spectacle lens semi-finished product 10 with different outer diameters at one and the same positioning retainer 22 so that the desired diameter range—typically, for example, 50 mm to 80 mm—of the processed spectacle lenses can be covered. Whereas spectacle lens semi-finished products 10 of larger diameter in accordance with FIG. 6 are seated by the orientation structure 20 thereof further above and radially further outwardly with respect to the center axis 46 on the projections 58, spectacle lens semi-finished products 10 of smaller diameter in correspondence with FIG. 7 stand closer to the base body 48 by their orientation structure 20 and are in contact with the projections 58 radially further inwardly with respect to the center axis 46.

It will be apparent to the person ordinarily skilled in the art that this flexibility of the positioning retainer 22, which concerns the dimensions of the spectacle lens semi-finished products 10 able to be retained, is an aspect of the positioning retainer 22 which is of great advantage even regardless of the possibility of transporting the spectacle lens semi-finished product 10 together with the positioning retainer 22 with clear and unambiguous positioning and orientation. Thus, for use such a positioning retainer 22 can obviously also—and especially—be secured in stationary location, for example to a processing device, so as to position and orientate dimensionally different spectacle lens semi-finished products 10 for subsequent processes.

FIGS. 8 to 11 illustrate—in, as already mentioned, a depiction substantially over-size in terms of dimensions—the effect of the configuration of the projections 58 with slightly different diameters d and D (see, also, FIGS. 4 and 5). In the combination, which is shown in FIGS. 8 to 11, of positioning retainer 22 and spectacle lens semi-finished product 10, at which the orientation sections 36, 38, 40 of the orientation structure 20 formed as grooves in correspondence with FIGS. 2 and 3 have identical geometries and dimensions, one (40) of the orientation sections 36, 38, 40 then has a clear opening width W (cf. FIG. 11) which is smaller than the diameter D of the associated projection 58 at the positioning retainer 22. The remaining orientation sections 36, 38, which are formed as grooves, of the orientation structure 20 at the spectacle lens semi-finished product 10 on the other hand have a (identical) clear opening width W (see FIG. 9), which is greater than the diameter d of the associated projections 58 at the positioning retainer 22. As a result, the projection 58 with the greater diameter D at the orientation structure 20 of the spectacle lens semi-finished product 10 bears in the first case (cf. FIG. 11) at two opposite positions 64 at the groove edge of the orientation section 40, whereas the projections 58 with the smaller diameter d at the orientation structure 20 of the spectacle lens semi-finished product 10 in the second case (see FIG. 9) come into contact in each instance at only one place 65 in the respective groove base of the orientation sections 36, 38. This stabilizes the rotational position of the spectacle lens semi-finished product 10 about the center axis 46 of the positioning retainer 22 in simple manner, which is conducive to a particularly high level of accuracy of the workpiece retainer.

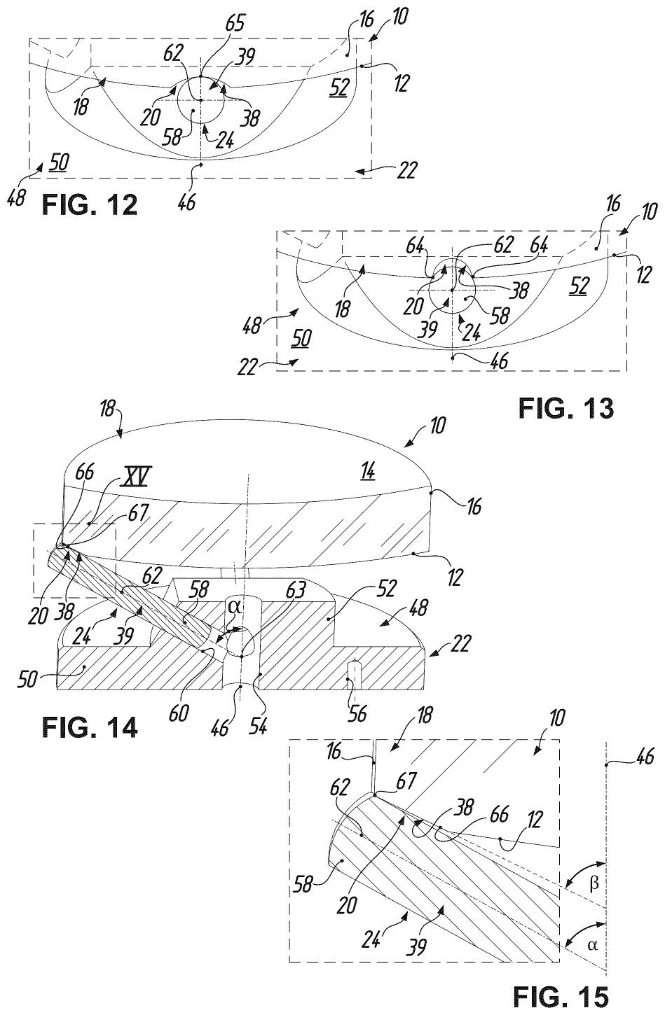

In this connection, FIGS. 12 and 13 additionally illustrate that the same stabilization effect for the rotational position of the spectacle lens semi-finished product 10 about the center axis 46 can also be achieved if in the case of identical diameters of all projections 58 of the positioning structure 24 at the positioning retainer 22 the grooves of the orientation sections 36, 38, 40 of the orientation structure 20 are formed with different widths at the spectacle lens semi-finished product 10 analogously to FIG. 2. In the case of a wider groove there is again contact at one position 65 in the groove base (cf. FIG. 12), whereas in the case of a narrower groove there is contact at two positions 64 at the groove edge (see FIG. 13). Accordingly, it is possible to also achieve such positioning and orientation effects through the orientation sections 36, 38, 40 of the orientation structure 20 being formed with different geometries and/or with different dimensions.

With respect to the first embodiment, FIGS. 14 and 15 additionally show a further possibility of influencing the capability of definition or the accuracy of retention of the spectacle lens semi-finished product 10 at the positioning retainer 22. A combination of positioning retainer 22 and spectacle lens semi-finished product 10 retained thereat is illustrated again here, wherein the orientation sections 36, 38, 40, which once more are formed as grooves in correspondence with FIGS. 2 and 3, of the orientation structure 20 at the spectacle lens semi-finished product 10 each have a substantially straight groove base 66 (see FIG. 15). In that case each groove base 66 includes with the center axis 46 of the base body 48 of the positioning retainer 22 an angle β different from the angle α which the obliquely extending projections 58 of the positioning retainer 22 include with the center axis 46 of the base body 48. The difference of the angle β from the angle α can then lie, for example, between 2° and 40°, preferably between 5° and 15°.

It is apparent from, in particular, FIG. 15 that due to this angle difference a contact between the respective orientation section 36, 38, 40 of the spectacle lens semi-finished product 10 and the respectively associated positioning section 37, 39, 41 of the positioning retainer 22 occurs at only one position 67. If the angle β is greater than the angle α, as shown, then the contact position 67 lies at the radially outer end of the groove. On the other hand, if the angle β is smaller than the angle α then the contact position is at the radially inner end of the groove.

With respect to the first embodiment it is additionally to be mentioned at this point with respect to use of the positioning retainer 22 that at any place of the process chain according to FIG. 1 after the main step ii) of generating in which the spectacle lens semi-finished product 10 was provided with the orientation structure 20 in the sub-step ii.c) the thus-equipped spectacle lens semi-finished product 10 can be picked up without orientation by a handling system with, for example, a workpiece holding head 26 in correspondence with FIG. 2. The handling system then positions the picked-up, unoriented spectacle lens semi-finished product 10 substantially centrally, but in any rotational position over the positioning retainer 22. The spectacle lens semi-finished product 10 is subsequently rotated by the handling system until the orientation sections 36, 38, 40, which here are formed as grooves, of the orientations structure 20 lie over the projections 58, which form the positioning sections 37, 39, 41 of the positioning structure 24, of the positioning retainer 22. At this position the spectacle lens semi-finished product 10 then “detents” in the positioning retainer 22 and is deposited with clear definition in location and position, as is shown in, for example, FIGS. 6 to 8.

An additional optical recognition of the orientation structure 20 at the spectacle lens semi-finished product 10 in the case of its deposit in or at the positioning retainer 22 can optionally be provided and used for a first approximation of location and position, so that the spectacle lens semi-finished product 10 is deposited on the positioning retainer 22 with preliminary orientation. As a result, the mechanical deposit can be simplified and accelerated and the risk of damage to the spectacle lens semi-finished product 10 during deposit minimized.

Thereafter the spectacle lens semi-finished product 10, which is unambiguously positioned and oriented in three dimensions in or at the positioning retainer 22 by mechanically positive engagement, can be picked up again, for example by a workpiece holding head 26 as illustrated in FIG. 2, from the positioning retainer 22 for further processing. The further processing of the spectacle lens semi-finished product 10 thus arranged in clearly defined manner in three dimensions with respect to location and position can then take place at the workpiece holding head 26 itself—such as, for example, block-free marking in the main step iv) of the process chain according to FIG. 1—or in or at another retainer (not shown), in or at which the spectacle lens semi-finished product 10 was then deposited by the workpiece holding head 26 before the respective further processing.

It will be apparent to the person ordinarily skilled in the art that the orientation structure 20 at the workpiece and the positioning retainer 22 can be used in the processing chain not only for fresh recognition or determination of location and position of the spectacle lens semi-finished product 10, but also for oriented transfer of the spectacle lens semi-finished product 10. For that purpose the positioning retainer 22 can, as already mentioned further above, be placed in a job tray so that the handling system of the generator can deposit the spectacle lens semi-finished product 10 with the orientation structure 20 correctly positioned on the positioning retainer 22, whereupon—after transport of the spectacle lens semi-finished product 10 in the job tray—the respective handling system of downstream machines in the process chain can again pick up or remove the spectacle lens semi-finished product 10 from there in oriented manner. Thus, the spectacle lens semi-finished product 10 could, for example, be placed on the lens holder in the main step iii) of block-free polishing without repeated determination of location and position.

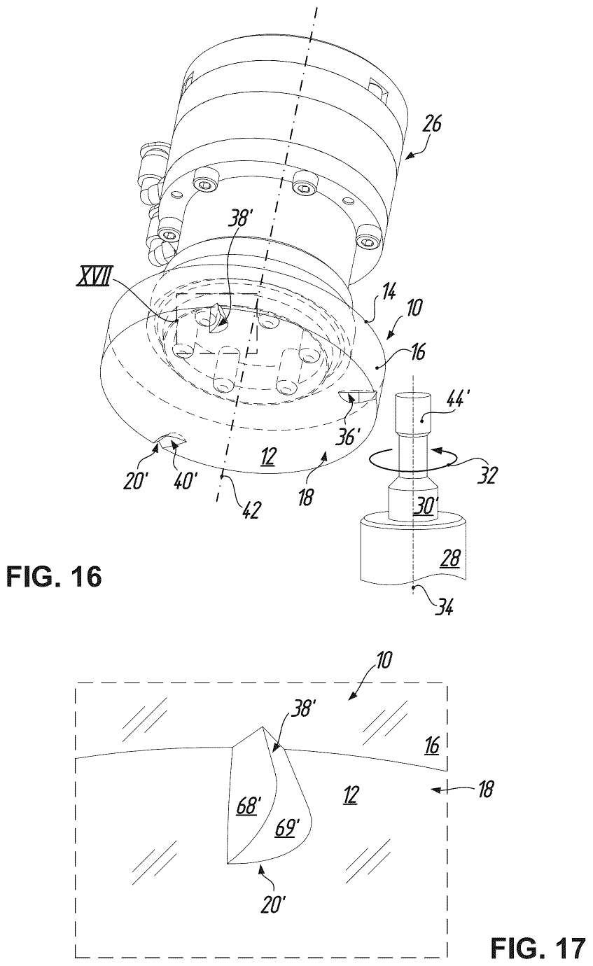

In view of the above explanations with regard to the first embodiment the second embodiment shall be described in the following on the basis of FIGS. 16 to 23 only to the extent that it significantly differs from the first embodiment and to the extent appearing necessary for further understanding of the invention.

In the case of the second embodiment as well, firstly and in accordance with FIGS. 16 and 17 three grooves with non-uniform angular spacings from one another with respect to the center axis 42, for example with angular positions of 0°, 90° and 225° in counter-clockwise sense as shown in FIG. 16, are milled as orientation sections 36′, 38′, 40′ of the orientation structure 20′ into the edge region 18 of the spectacle lens blank 10, which is held at the workpiece holding head 26, starting here from the front side 12 of the workpiece. However, for that purpose use is made of a somewhat differently shaped end mill 30′ which in the manner of a base-cutting and flank-cutting groove mill also carries at the end face thereof main cutters (not shown in detail) for producing a planar surface.

As a consequence of the angle adjustment of the center axis 34 of the end mill 30′ with respect to the center axis 42 of the workpiece 10 and due to the cutter geometry of the end mill 30′, which is capable of entering at the end face into the lens material before it is guided radially out of the lens material, a prismatic groove shape as shown in detail in FIG. 17 results. A planar surface 68′ (at the left in FIG. 17) or a curved—at least in a sub-region—surface 69′ (on the right in FIG. 17) arises at the groove, which is created as a respective orientation section 36′, 38′ or 40′ of the orientation structure 20′, in accordance with FIG. 17 in correspondence with the position of the respective geometry-generating cutter or cutters of the end mill 30′ at the end or circumference. At the exit of the groove in the edge 16 of the workpiece 10 the groove has a substantially triangular groove cross-section (see also FIG. 22).

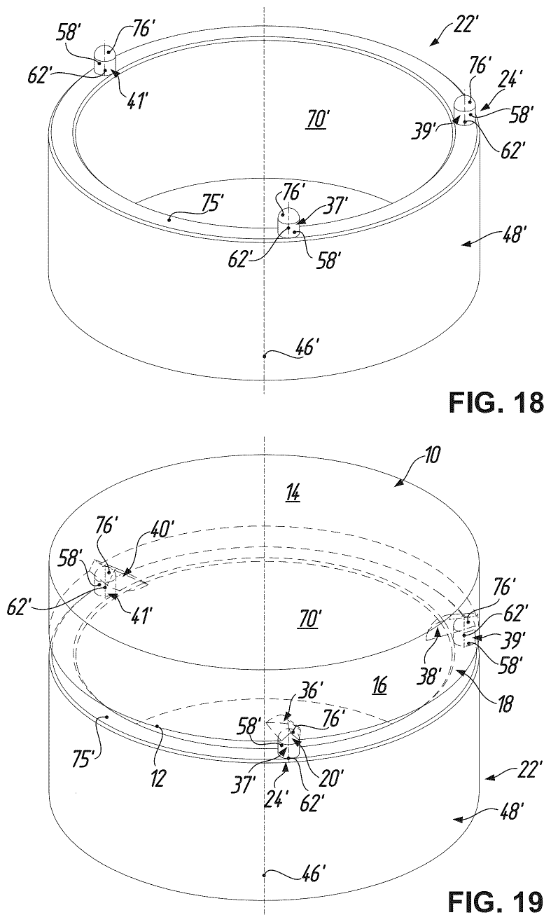

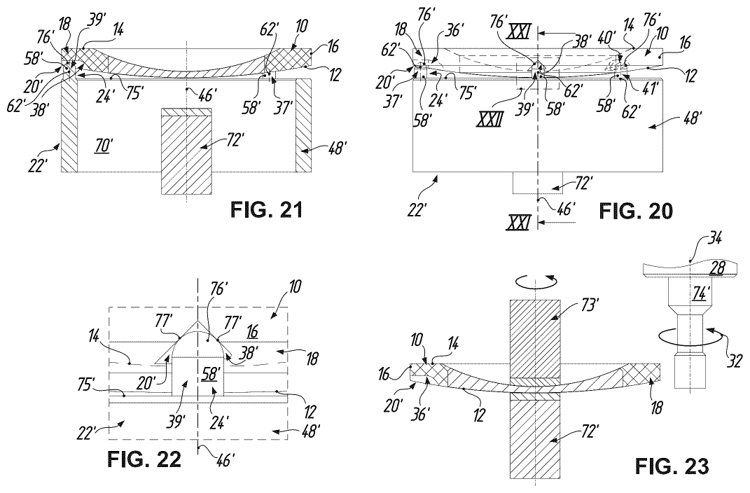

In accordance with the second embodiment at the outset it is obvious at the positioning retainer 22′, which is shown separately in FIG. 18, that the base body 48′ thereof is formed to be annular or hollow-cylindrical with a central passage 70′ around the center axis 46′ of the base body 48′. This enables, in particular, gripping or clamping of the spectacle lens semi-finished product 10, which is positioned and oriented at the positioning retainer 22′, by the base body 48′, for example by a pairing of die 72′ and mating die 73′, as indicated in FIGS. 20, 21 and 23. If the spectacle lens semi-finished product 10 is correspondingly held, the positioning retainer 22′ in FIGS. 20 and 21 can be moved away downwardly—or conversely the workpiece upwardly or both downwardly and upwardly—so that the spectacle lens semi-finished product 10 is free for further processing.

For that purpose, by way of example the final processing of the edge shape (sub-step vi.b) in FIG. 1) by an end mill 74′ is illustrated in FIG. 23. Cross-hatching at the workpiece 10 also indicates here that spectacle lens material which is removed in the final edge processing, wherein it is additionally apparent that in this edge processing the edge region 18 of the workpiece 10 with the temporary orientation structure 20′ is also removed.

In the case of the second embodiment, according to FIGS. 18 and 19 the three positioning sections 37′, 39′, 41′—again arranged at 0°, 90° and 225° with respect to the center axis 46′ of the base body 48′—of the positioning retainer 22′ are formed by pin-shaped projections 58′ which in accordance with the longitudinal section according to FIG. 21 (see, there, the lefthand side) are formed integrally with the base body 48′. By contrast with the first embodiment, in the second embodiment the projections 58′ extend by the center axes 62′ thereof substantially parallel to the center axis 46′ of the base body 48′ away from an end face 75′ of the base body 48′ and by the free ends 76′ thereof form the positioning sections 37′, 39′, 41′ of the positioning structure 24′ of the positioning retainer 22′.

The projections 58′ are in that case of spherically domed configuration at the free ends 76′. As a result, as can be readily seen in the enlargement according to FIG. 22, at one of the projections 58′ there is again contact at two positions 77′ with the associated orientation section 38′, obviously assuming that the diameter of the corresponding projection 58′ is smaller than the clear groove width of the orientation section 38′. Due to production tolerances this contact combination between orientation structure 20′ and positioning structure 24′ is present at only one of the projections 58′, while at the other projections 58′ there is one-sided contact with the respective orientation section 36′ or 40′. This can also be encouraged or obliged by one of the projections 58′ having a somewhat greater—for example by 0.4 mm—diameter than the other projections 58′, so that in the case of identical dimensions of the orientation sections 36′, 38′, 40′ the thicker projection bears at two positions 77′. The stabilization effect already described further above again arises for the rotational position of the spectacle lens semi-finished product 10 about the center axis 46′.

With respect to the second embodiment it may also be mentioned at this point that the contact points formed by the projections 58′ can be of fixed location as shown in FIGS. 18 to 22, whereby retention of spectacle lens semi-finished products 10 with a fixed lens diameter is possible. However, in a variant (not illustrated here) the projections 58′ can also be arranged to be radially displaceable with respect to the center axis 46′, which in the embodiment with parallel aligned projections 58′ in turn also enables deposit and orientation of spectacle lens semi-finished products 10 with different lens diameters.

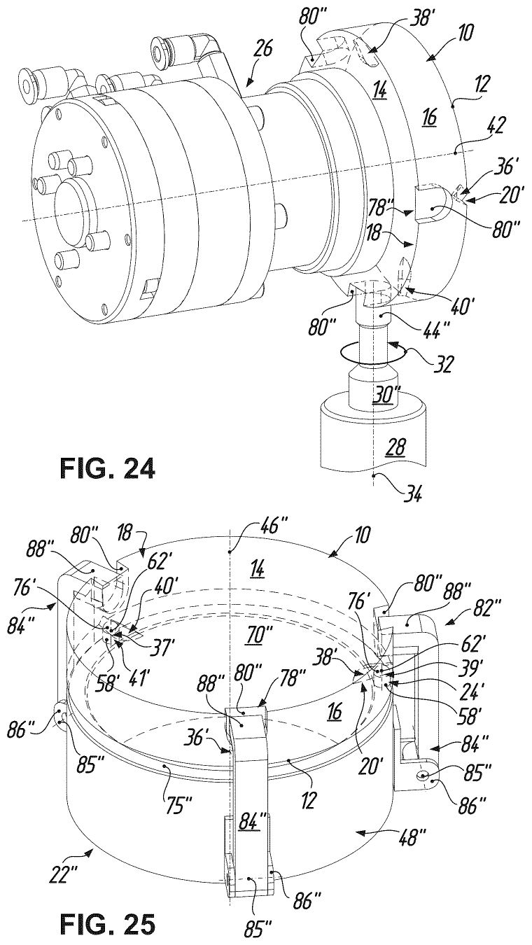

FIGS. 24 and 25 illustrate a third embodiment in which the orientation structure 20′ at the spectacle lens semi-finished product 10 and also the positioning structure 24′ at the positioning retainer 22″ are configured as in the case of the second embodiment according to FIGS. 16 to 23. Reference can thus again be made to the preceding description with respect to the relevant features and effects.

In this embodiment there is now an additional feature that the main step ii) of generating comprises a further sub-step in which a holding structure 78″ is additionally formed in the edge region 18 of the spectacle lens semi-finished product 10, wherein after the mechanically positive alignment of the spectacle lens semi-finished product at the positioning retainer 22″ the spectacle lens semi-finished product 10 is held with the assistance of the holding structure 78″ at the positioning retainer 22″ while further processing or transport of the spectacle lens semi-finished product 10 takes place.

In this connection, FIG. 24 shows that the holding structure 78″ at the spectacle lens semi-finished product 10 has three holding grooves 80″ formed by an end mill 30″, which can also be utilized for formation of the orientation sections 36′, 38′, 40′. In the illustrated embodiment the three holding grooves 80″ are placed at the edge 16 of the spectacle lens semi-finished product 10 and, in particular, in angular positions with respect to the center axis 42 in correspondence with the orientation sections 36′, 38′, 40′, although open not towards the front side 12 of the spectacle lens semi-finished product 10, but towards the rear side 14 thereof. In other words, the holding grooves 80″ of the holding structure 78″ are formed to be respectively opposite the orientation sections 36′, 38′ 40′ of the orientation structure 20′, but remote therefrom, at the spectacle lens semi-finished product 10.

In this embodiment the positioning retainer 22″ is provided with a holding arrangement 82″ adapted to engage the holding structure 78″ at the spectacle lens semi-finished product 10 so as to hold the spectacle lens semi-finished product 10 with its orientation structure 20′ in mechanically positive engagement with the positioning structure 24′ at the positioning retainer 22″. FIG. 25 shows this state, i.e. the combination of positioning retainer 22″ with holding arrangement 82″ and spectacle lens semi-finished product 10 with holding structure 78″, which is engaged by the holding arrangement 82″ of the positioning retainer 22″ so that the spectacle lens semi-finished product 10 is held at the positioning retainer 22″.

According to FIG. 25 the holding arrangement 82″ in the illustrated embodiment comprises a plurality of—here three—downholders 84″ which with respect to the center axis 46″ of the base body 48″ of the positioning retainer 22″ are arranged at the base body 48″ to be distributed at an angular spacing from one another and, in particular, in a distribution corresponding with the positioning sections 37′, 39′, 41′ of the positioning retainer 22″. The downholders 84″ are each articulated to the annular base body 48″ of the positioning retainer 22″ to be pivotable (pivot axes 85″ in FIG. 25), for which purpose respectively associated fork-shaped bearing blocks 86″ are mounted on the base body 48″. The downholders 84″ are themselves formed to be angled so that they are capable of mechanically positively engaging by the angled free ends 88″ thereof the holding grooves 80″ at the spectacle lens semi-finished product 10 as shown in FIG. 25, so as to hold the spectacle lens semi-finished product 10 in securely positioned and oriented manner at the positioning retainer 22″ during transport or further processing.

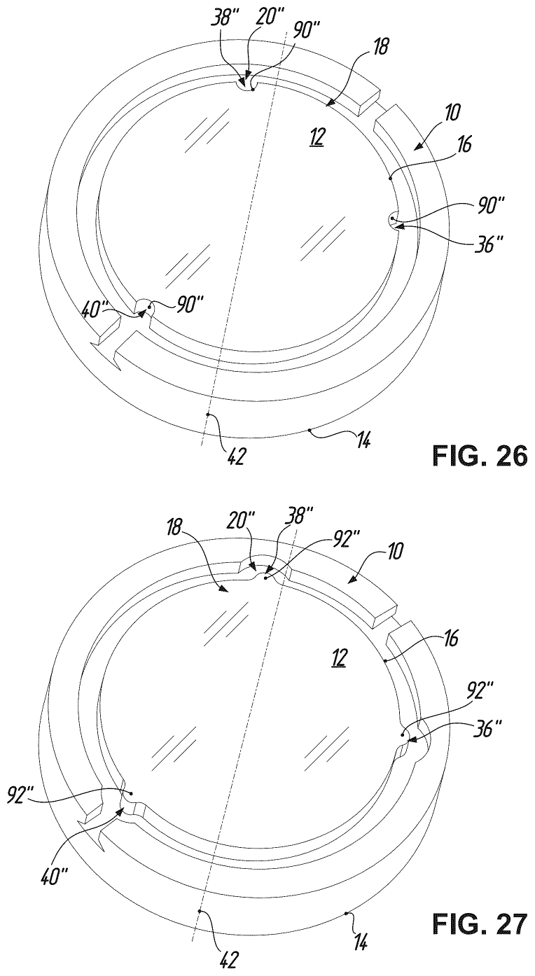

Finally, FIGS. 26 and 27 additionally show variants of spectacle lens semi-finished products 10 in which the orientation sections 36″, 38″, 40″ of the orientation structure 20″ are formed as grooves 90″ (FIG. 26) or as webs 92″ (FIG. 27) at the spectacle lens semi-finished product 10. The spectacle lens semi-finished products 10 shown here were produced by the method for processing of, in particular, spectacle lenses of plastic by machining, which is the subject of earlier German patent application DE 10 2021 004 831.8 of the same applicant (see, there, in particular FIG. 6) and in which preliminary edge processing can also be carried out in a special mode and manner during the block-free generating. In that regard, FIGS. 26 and 27 also illustrate that the orientation structures 20″ at the spectacle lens semi-finished product 10 can be formed in a particularly simple manner in the earlier method.

In a method of producing spectacle lenses a finished part with predetermined surface geometries at a front side and a rear side remote therefrom and with a contoured edge therebetween is formed by removal and/or application of material beginning with a blank and via a semi-finished product. In that case, in a main step of generating an optically active shape of the spectacle lens there is formed the semi-finished product which has an edge region in which an orientation structure is also formed. Location and position of the semi-finished product in three dimensions are unambiguously recognized and fixed with the help of a positioning retainer, which is arranged in a defined manner in three dimensions, for at least one succeeding main step of further processing, for which purpose the positioning retainer has a positioning structure with which the semi-finished product is aligned by its orientation structure by mechanical interlocking before the semi-finished product is held and further processed or transported. Suitable positioning retainers for that purpose are also disclosed, as also combinations of positioning retainer and semi-finished product placed thereon. The concept described herein makes possible in a “block-free” processing chain transfer of location and position data which in the prior art takes place through the blocking member. It is thereby possible to avoid a laborious and error-susceptible measuring procedure in downstream processes, for example in the marking process or the edge processing process.

### REFERENCE NUMERAL LIST

10 spectacle lens
12 front side
14 rear side
16 edge
18 edge region
20, 20′, 20″ orientation structure
22, 22′, 22″ positioning retainer
24, 24′ positioning structure
26 workpiece holding head
28 milling spindle
30, 30′, 30″ end mill
32 movement arrow
34 center axis
36, 36′, 36″ orientation section
37, 37′ positioning section
38, 38′, 38″ orientation section
39, 39′ positioning section
40, 40′, 40″ orientation section
41, 41′ positioning section
42 center axis
44, 44′, 44″ outer circumference
46, 46′, 46″ center axis
48, 48′, 48″ base body
50 base
52 step
54 securing bore
56 orientation cut-out
58, 58′ projection
60 securing bore
62, 62′ center axis
63 common point
64 contact position at groove edge
65 contact position in groove base
66 groove base
67 contact position at groove start or groove end
68′ planar surface
69′ curved surface
70′, 70″ passage
72 die
73′ mating die
74 end mill
75′, 75″ end face
76′ free end
77 contact position
78″ holding structure
80″ holding groove
82″ holding arrangement
84″ downholder
85″ pivot axis
86″ bearing block
88″ free end
90″ groove
92″ web
d smaller diameter of the projection
greater diameter of the projection D
clear opening width of the groove W

What is claimed is:

1. A method for producing spectacle lenses (10), in which beginning with a blank and via a semi-finished product a finished part with predetermined surface geometries at two sides (12, 14), namely a front side (12) and a rear side (14) remote therefrom, and with a contoured edge (16) between the two sides (12, 14) is formed through removal and/or application of material, comprising the following main steps:
i) providing or creating the blank, which is to be processed at at least one side (12, 14) as well as at the edge (16);
ii) generating an optically active shape of the spectacle lens (10) by removal and/or application of material on at least one side (12, 14) of the blank for formation of a semi-finished product having an edge region (18);
followed by at least one further main step from a group of main steps iii) to vi), comprising the main steps:
iii) polishing the semi-finished product at at least one of the sides (12, 14) for reducing surface roughness;
iv) marking the semi-finished product at at least one of the sides (12, 14) by a permanent marking;
v) coating the semi-finished product at at least one of the sides (12, 14) for enhancement of workpiece quality;
vi) forming a frame shape of the spectacle lens (10) by removal and/or application of material in the edge region (18);
wherein the main step ii) of generating comprises a sub-step ii.c) in which an orientation structure (20; 20′; 20″) is formed in the edge region (18) of the semi-finished product;
wherein in a following step a positioning retainer (22; 22′; 22″) positionable in defined manner in three dimensions is provided, with the help of which the location and position of the semi-finished product in three dimensions is unambiguously recognized and fixed, for which purpose the positioning retainer (22; 22′; 22″) comprises a positioning structure (24; 24′; 24″) at which the semi-finished product is aligned by mechanically positive couple with its orientation structure (20; 20′; 20″) in the edge region (18); and
wherein the semi-finished product, which is retained at the positioning retainer (22; 22′; 22″) and positioned and orientated in that way, together with the positioning retainer (22; 22′; 22″) is transported for further processing in at least one of the further main steps iii) to vi) in which re-establishing of location and position of the semi-finished product is unnecessary.

2. A method for producing spectacle lenses (10) according to claim 1, wherein the orientation structure (20; 20′; 20″) is formed at the spectacle lens semi-finished product by removal, particularly by machining, of material.

3. A method for producing spectacle lenses (10) according to claim 2, wherein the orientation structure (20; 20′; 20″) has at least three orientation sections (36, 38, 40; 36′, 38′, 40′; 36″, 38″, 40″) which are formed in an irregular arrangement about a center axis (42) of the spectacle lens semi-finished product.

4. A method for producing spectacle lenses (10) according to claim 3, wherein the individual orientation sections (36, 38, 40; 36′, 38′, 40′; 36″, 38″, 40″) are formed at positions in the edge region of the front side (12), in the edge region of the rear side (14), at the edge (16), at the transition from the front side (12) to the edge (16) or at the transition from the rear side (14) to the edge (16) of the spectacle lens semi-finished product or are formed to be distributed at these locations.

5. A method for producing spectacle lenses (10) according to claim 4, wherein the orientation sections (36, 38, 40; 36′, 38′, 40′; 36″, 38″, 40″) of the orientation structure (20; 20′; 20″) are formed at the spectacle lens semi-finished product with different geometries and/or with different dimensions and/or at different angular spacings from one another with respect to the center axis (42) of the spectacle lens semi-finished product.

6. A method for producing spectacle lenses (10) according to claim 5, wherein the orientation sections (36, 38, 40; 36′, 38′, 40′; 36″, 38″, 40″) of the orientation structure (20; 20′; 20″) are formed as grooves or webs at the spectacle lens semi-finished product.

7. A method for producing spectacle lenses (10) according to claim 6, wherein the main step ii) of generating comprises a further sub-step in which a holding structure (78″) is formed in the edge region (18) of the spectacle lens semi-finished product, and wherein after the mechanically positive alignment of the spectacle lens semi-finished product with the positioning retainer (22″) the spectacle lens semi-finished product is held at the positioning retainer (22″) with the assistance of the holding structure (78″) while the further processing or the transport of the spectacle lens semi-finished product takes place.

8. A positioning retainer (22) for a spectacle lens semi-finished product, for use in a method for producing spectacle lenses (10) according to claim 1, comprising a base body (48), which has a center axis (46) and which carries a positioning structure (24) having at least three positioning sections (37, 39, 41) for the spectacle lens semi-finished product, the positioning sections being placed in an irregular arrangement about the center axis (46) and being formed by projections (58) which extend obliquely with respect to the center axis (46) of the base body (48) and/or are arranged to be radially displaceable, wherein the positioning structure (24) overall has a geometry, in adaptation to which an orientation structure (20) at the spectacle lens semi-finished product can be formed so that the location and position of a spectacle lens semi-finished product retained at the positioning retainer (22) can be unambiguously and clearly defined with respect to the base body (48) by a mechanically positive couple between the positioning structure (24) at the positioning retainer (22) and the orientation structure (20) at the spectacle lens semi-finished product.

9. A positioning retainer (22) according to claim 8, wherein the projections (58) of the positioning structure (24) in the form of pins are mounted on the base body (48) or formed integrally with the base body.

10. A positioning retainer (22) according to claim 9, wherein the projections (58) as seen in plan view are arranged at a non-uniform angular spacing from one another with respect to the center axis (46) of the base body (48) and/or wherein the projections (58) project to the same extent from the base body (48) and/or wherein the projections (58) have a circular cross-section and/or wherein one of the projections (58) has a slightly larger diameter (D) than the other projections (58).

11. A positioning retainer (22) according to claim 9, wherein the projections (58) extending obliquely with respect to the center axis (46) of the base body (48) intersect by the center axes (62) thereof the center axis (46) of the base body (48) and/or wherein the center axes (62) of the projections (58) include with the center axis (46) of the base body (48) an angle (a) which is greater than or equal to 30° and smaller than or equal to 60° and/or wherein the projections (58) form by the circumferential surfaces thereof the positioning sections (37, 39, 41) of the positioning structure (24).

12. A positioning retainer (22) according to claim 8, wherein the obliquely extending projections (58) as seen in plan view along the center axis (46) of the base body (48) extend either radially outwardly from a central base body (48) or radially inwardly from a base body, which has attachment or securing points arranged substantially on a notional circle about a center axis of the positioning retainer for the projections extending at an inclination.

13. A positioning retainer (22″) according to claim 8, wherein the positioning retainer (22″) is provided with a holding arrangement (82″) adapted to engage the spectacle lens semi-finished product, particularly a holding structure (78″) at the spectacle lens semi-finished product, so as to hold the spectacle lens semi-finished product by its orientation structure (20′) in the mechanically positive engagement with the positioning structure (24′) at the positioning retainer (22″).

14. A positioning retainer (22″) according to claim 13, wherein the holding arrangement (82″) has a plurality of downholders (84″) which with respect to the center axis (46″) of the base body (48″) of the positioning retainer (22″) are arranged to be distributed at the base body (48″) at an angular spacing from one another and/or wherein the downholders (84″) of the holding arrangement (82″) are pivotably articulated to the base body (48″) of the positioning retainer (22″) and/or wherein the downholders (84″) of the holding arrangement (82″) are of angled configuration.

15. A combination of a positioning retainer (22; 22″) according to claim 8 and a spectacle lens semi-finished product, which has in the edge region (18) an orientation structure (20; 20′; 20″) which is formed according to in particular the method according to any one of claims 1 to 7 and which mechanically positively engages the positioning structure (24; 24′) of the positioning retainer (22; 22″).

16. A combination of a positioning retainer (22) and a spectacle lens semi-finished product according to claim 15, wherein the orientation sections (36, 38, 40), which are formed as grooves, of the orientation structure (20) at the spectacle lens semi-finished product each have a substantially straight groove base (66) which includes with the center axis (46) of the base body (48) of the positioning retainer (22) an angle (β) differing from the angle (α) which the obliquely extending projections (58) of the positioning retainer (22) include with the center axis (46) of the base body (48), wherein the difference of the angle (β) from the angle (a) is preferably between 2° and 40° and more preferably between 5° and 15°.

17. A combination of a positioning retainer (22) and a spectacle lens semi-finished product according to claim 15, wherein one of the orientation sections (36, 38, 40), which are formed as grooves, of the orientation structure (20) at the spectacle lens semi-finished product has a clear opening width (W) smaller than a diameter (D) of the associated projection (58) at the positioning retainer (22), whereas the remaining orientation sections (36, 38, 40), which are formed as grooves, of the orientation structure (20) at the spectacle lens semi-finished product have a clear opening width (W) greater than a diameter (d) of the associated projections (58) at the positioning retainer (22).

18. A combination of a positioning retainer (22″) and a spectacle lens semi-finished product according to claim 15, wherein the holding arrangement (82″) of the positioning retainer (22″) engages the spectacle lens semi-finished product, particularly the holding structure (78″) provided thereat, so that the spectacle lens semi-finished product is held at the positioning retainer (22″).

19. A method for producing spectacle lenses (10) according to claim 1, wherein the main step ii) of generating comprises a further sub-step in which a holding structure (78″) is formed in the edge region (18) of the spectacle lens semi-finished product, and wherein after the mechanically positive alignment of the spectacle lens semi-finished product with the positioning retainer (22″) the spectacle lens semi-finished product is held at the positioning retainer (22″) with the assistance of the holding structure (78″) while the further processing or the transport of the spectacle lens semi-finished product takes place.
